(19) United States
(12) Patent Application Publication
(10) Pub. No.: US 2024/0103123 A1
(43) Pub. Date: Mar. 28, 2024

(54) RADAR-BASED SENSING, POSITIONING, AND COMMUNICATIONS SYSTEM

(71) Applicant: BITSTRATA SYSTEMS INC., Saskatoon (CA)

(72) Inventors: Ian Robert Meier, Saskatoon (CA); Michael David Lockerbie, Saskatoon (CA)

(21) Appl. No.: 18/275,084

(22) PCT Filed: Feb. 2, 2022
(86) PCT No.: PCT/CA2022/050151

§ 371 Date: Jul. 31, 2023

Related U.S. Application Data
(60) Provisional application No. 63/145,222, filed on Feb. 3, 2021.
(60) Provisional application No. 63/155,110, filed on Mar. 1, 2021.
(60) Provisional application No. 63/229,345, filed on Aug. 4, 2021.
(60) Provisional application No. 63/239,077, filed on Aug. 31, 2021.

(51) Int. Cl. G01S 7/00; H04L 27/00

(52) U.S. Cl. CPC G01S 7/006; H04L 27/0006; G01S 2013/9316

(57) ABSTRACT

Systems and methods for providing a communications and relative positioning capability using frequency-modulated continuous-wave radar installed on multiple mobile and/or stationary objects, providing secure/reliable determination of signal origin from a select one of a plurality of geographically mobile machines, equipment, devices, or systems and subsequent selective establishment/facilitation of direct/deterministic/reliable communication therewith.

### CROSS REFERENCE TO RELATED APPLICATIONS

This present patent document is a § 371 nationalization of PCT Application Serial Number PCT/CA2022/050151, filed November Feb. 2, 2022, designating the United States, which is hereby incorporated in its entirety by reference. This application also claims the benefit of the filing date under 35 U.S.C. § 119(e) of U.S. Provisional Application Ser. No. 63/145,222 filed on Feb. 3, 2021, U.S. Provisional Application Ser. No. 63/155,110 filed on Mar. 1, 2021, U.S. Provisional Application Ser. No. 63/229,345 filed on Aug. 4, 2021, and U.S. Provisional Application Ser. No. 63/239,077 filed on Aug. 31, 2021, the entire disclosures of which are incorporated by reference in their entirety.

### FIELD

Embodiments relate to systems and method for communicating using frequency-modulated continuous-wave radar signals.

### BACKGROUND

Establishing/enabling ad-hoc secure/deterministic/reliable wireless communications selectively and deterministically between two or more machines or devices, e.g., arbitrary machines/devices, among a plurality of available machines/devices, particularly, when one or more of those machines/devices are mobile/in motion, may be challenging, particularly in environments which themselves pose challenging conditions, such as outdoors, industrial settings, etc. Such challenges include an initiating machine/device determining which particular machine/device, or otherwise discriminating among multiple machines/devices, with which to establish communications, validating by the initiating machine/device that it is in fact communicating with the intended machine/device, maintaining a reliable communications channel to ensure the desired communications can be maintained, etc.

Frequency-modulated continuous-wave (FMCW) radar is an imaging technology that allows for the remote detection of the position and speed of multiple objects. As it is a radio-based technology, it has many advantages over other sensing technologies which may be impaired by environmental conditions, such as optical/vision-based systems, which may be impaired, for example, by dust, fog, rain, etc. and ultrasound-based systems, which may be impaired, for example, by dust and wind. By operating in the millimeter wavelength region, the radar's antenna geometries become miniaturized, allowing for very small-scale antenna arrays. This results in an extremely robust and compact sensing device, able to detect the location and speed of objects in its surroundings. Millimeter wave (mmWave) is a class of radar technology that uses short wavelength electromagnetic waves. Radar works by transmitting electromagnetic wave signals that objects in the signal's path then reflect. By capturing the reflected signal, a radar system can determine the range, velocity, and angle of the objects.

An FMCW radar device operates by wirelessly transmitting a chirp signal, which starts at one frequency and linearly ramps to another, higher or lower frequency, and repeats. Any portion of the signal reflected off an object back toward a receiver antenna is then mixed, or multiplied with the transmitted signal, which generates an intermediate frequency (I/F) signal. The frequency of the I/F signal is equal to the difference in frequency between the transmitted and received signals, that is proportional to the amount of time the transmit chirp was active before the reflected signal was received. This time is equal to the signal's propagation delay from the transmit antenna to the object plus the propagation delay from the object to the receive antenna. Because the signal travels at the speed of light, the distance between the radar antennas and the object can be determined or otherwise derived by multiplying the average of these two propagation delay times by the speed of light. The speed of the object may also be determined by measuring the phase shift of the I/F signal from chirp to chirp. The angle between the object and the radar antennas may be measured by using an array of receive antennas and using the phase shift between the concurrently-received signals to calculate the angle of arrival. The direction of the transmitted signal may also be steered using a phased array of transmit antennas. This technique feeds the transmitted signal to different antennas with different phase delays, allowing the direction of the transmitted signal to be adjusted or steered, focusing the transmitted signal in the specific direction. This technology is available in a highly integrated package, for example in the IWR6843AOP manufactured by Texas Instruments. The IWR6843AOP operates from 60 to 64 GHz, allowing for a very small form factor. The IWR6843AOP integrates all FMCW radar functions including transmitter and receiver antenna arrays in a 15 mm by 15 mm package.

While a conventional FMCW radar device such as the IWR6843AOP is able to locate objects in space, the identity and any other information about any detected objects cannot be determined thereby.

### BRIEF DESCRIPTION OF THE FIGURES

FIG. 1 depicts an example of different locations where the FMCW devices may be attached in a farming environment according to an embodiment.

FIG. 2 depicts an example of a FMCW system that coordinates multiple radar modules according to an embodiment.

FIG. 3 depicts an example method for communicating using FMCW radar according to an embodiment.

FIG. 4 depicts a demonstration of each of measurements detectable with the FMCW system according to an embodiment.

FIG. 5 depicts an example allocation of bandwidth channels according to an embodiment.

FIG. 6 depicts example locations of frequencies on a frequency spectrum plot according to an embodiment.

FIG. 7 depicts an example of a precision differential distance measurement instrument according to an embodiment.

FIG. 8 depicts another configuration that uses two different transmit frequencies according to an embodiment.

FIG. 9 depicts and example pattern of chirp phase instability according to an embodiment.

FIG. 10 depicts a graph showing an example set of 128 I/Q samples from a demodulated chirp according to an embodiment.

FIG. 11 depicts a graph showing the middle 128 samples from the filtered reference signal, extracted by using a 128-long finite-impulse-response (FIR), linear-phase filter, tuned to the nominal reference frequency according to an embodiment.

FIG. 12 depicts a graph showing the middle 128 samples from the filtered measurement signal, again extracted by using a 128-long FIR, linear-phase filter, tuned to the nominal measurement frequency according to an embodiment.

FIG. 13 depicts a block diagram of a system for determining the relative frequency and phase shift between the reference and measurement locations according to an embodiment.

FIG. 14 depicts a difference that represents the relative angle between the reference and measurement signals according to an embodiment.

FIG. 15 depicts an example of the phases of the reference and measurement locations due to chirp phase instability according to an embodiment.

FIG. 16 depicts a block diagram of a system for determining the relative frequency and phase shift between the reference and measurement locations according to an embodiment.

FIG. 17 depicts a block diagram of where the filter coefficients are time-symmetric, so the time-reversal is unnecessary, and a direct cross correlation of the chirp samples and filter coefficients may be used according to an embodiment.

FIG. 18 depicts an example diagram where a radar chirp is transmitted from the left, and reflects off materials A and B.

FIG. 19 depicts an example universal load cell according to an embodiment.

FIG. 20 depicts an example configuration that allows for the measurement of force in two directions in three different locations according to an embodiment.

### DETAILED DESCRIPTION

Embodiments provide systems and methods for communicating using FMCW hardware installed on multiple mobile and/or stationary objects, providing secure/reliable determination of signal origin from a select one of a plurality of geographically mobile or stationary devices and subsequent selective establishment/facilitation of direct/deterministic/reliable communication therewith. By enabling the radar system to communicate with objects detected thereby in such a manner that the communications are known to have originated from that particular object rather than some other source, the disclosed embodiments enable other important and secure information could be determined about the object or obtained therefrom.

As used herein, a frequency-modulated continuous-wave (FMCW) radar, FMCW device, or FMCW system may refer to a FMCW radar/device/system, which may comprise one or more discrete FMCW radar chips/circuits/devices/antennas, control systems, memories, other communications devices, etc., configured in accordance with the embodiments disclosed herein and affixed to an object or machine, such as a piece of agricultural machinery, e.g., a combine, grain cart, truck or trailer, grain auger, etc. In some embodiments, an FMCW system may refer to multiple discrete FMCW devices affixed at different locations/positions on one or more objects/machines. In some contexts, a device or system may refer to the combination of a suitably configured FMCW device/system and the object/machine to which it is affixed, such as with the operational or management control systems thereof. That is, the suitably configured FMCW device/system is coupled with the object/machine so as to provide a mode, medium or channel of communication by which the control/management systems of the object/machine may communicate with other similarly enabled objects/machines to implement the functions as described herein. In other embodiments, the FMCW device/system may be affixed to an object/machine but is otherwise coupled with a computing/control/management system remote therefrom, such as via a wireless network, e.g., cellular or Wi-Fi network, which directs the operations of the FMCW device and utilizes the mode, medium or channel of communication provided thereby. In other implementations, combinations of the aforementioned may be used as will be understood by one of ordinary skill in the art.

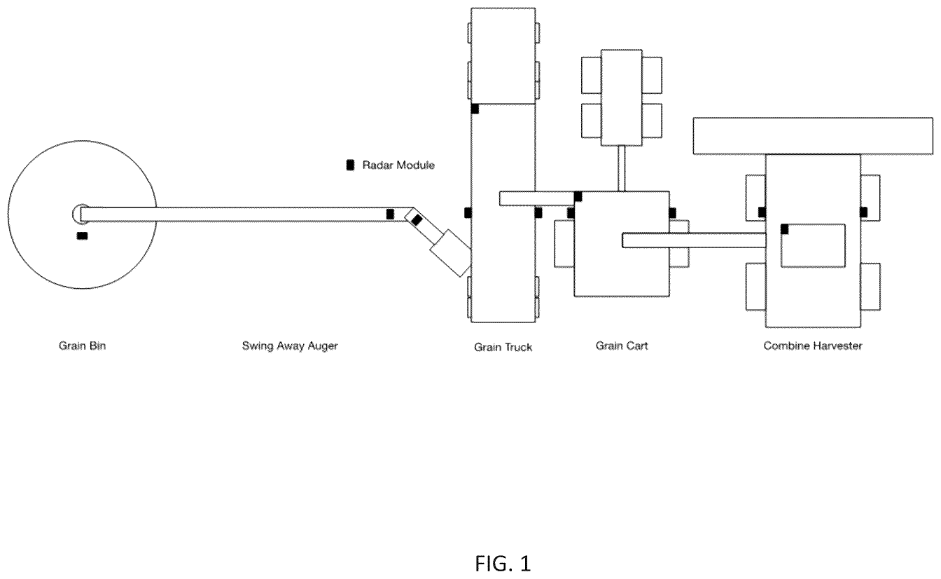

One application where communication between multiple machines/devices is important is a farm where it is desirable for various pieces of stationary and/or mobile agricultural equipment, e.g., combines, grain cars, trucks, etc., to automatically communicate with one another to, for example, automatically exchange information regarding loads and transfers thereof between pieces of equipment, e.g., for harvest/field or inventory management. FIG. 1 depicts an example of different locations where the FMCW devices may be attached in a farming/agriculture environment/operation. In FIG. 1, the FMCW may be attached or coupled with a grain bin, a swing away auger, a grain truck, a grain cart, and a combine harvester. In such an environment, it is important, for example, that a machine receiving a transfer of a load, such as grain, corn, etc., or portion thereof, “know” from which other machine it is receiving the transfer and/or that the transferring machine “know” to which machine it is transferring a load, or portion thereof. Further, it may be useful for these machines to exchange information regarding the initiation or cessation of a transfer event, the amount, e.g., weight or volume, of material transferred, such as for tracking purposes, etc.

Where multiple pieces of equipment are operating proximate to one another, e.g., multiple combines are operating in a field with multiple grain carts circulating between those combines, to pick up loads, and multiple trucks are waiting to haul those loads away, it may be difficult for automated systems to discriminate between particular pieces of equipment. For example, where each piece of equipment may be equipped with radio beacon identifiers, the close operating proximity, as well as radio interference and other environmental conditions, may make it difficult for a receiver to discriminate between those beacons to reliably establish communications with a particular piece of equipment. Further, optical, and acoustic based technologies may be impeded by machine movement or noise, environmental conditions, such as poor lighting or wind, e.g., at dusk/dawn or at night, dust or dirt, rain, etc.

In an embodiment, a system is provided wherein each piece of equipment includes two or more radar modules that are attached at various locations thereon. The radar modules/devices are configured to use frequency-modulated continuous-wave (FMCW) radar to determine their respective orientation to other equipment and to communicate information about themselves to the other equipment.

Each FMCW device may be packaged as a discrete sensor connected to power and data communications with one or more cables, such as controller area network (CAN), so that it can be easily located and oriented on the equipment for optimum performance. Multiple sensor devices may then connect to a single computing module, for data capture and analysis, machine control, and data backhaul such as via Wi-Fi, Ethernet, cellular, satellite or point-to-point wireless. Each of the FMCW devices may include multiple components such as transmit ΦTX) and receive (RX) radio frequency (RF) components e.g., antennas; analog components such as clocking; and digital components such as analog-to-digital converters (ADCs), microcontrollers (MCUs) and digital signal processors (DSPs) among other components. The FMCW devices transmit a frequency-modulated signal substantially continuously in order to measure range as well as angle and velocity. This differs from traditional pulsed-radar systems, which transmit short pulses periodically. The FMCW devices transmit a chirp signal and capture the signals reflected by objects in its path. The processing and sharing of the chirp signals and data collected therein by the disclosed embodiments allow the FMCW devices to establish a communication channel by which data may be exchanged. In an embodiment, multiple FMCW devices are in communication with a computing module that directs the FMCW devices and analyzes the results.

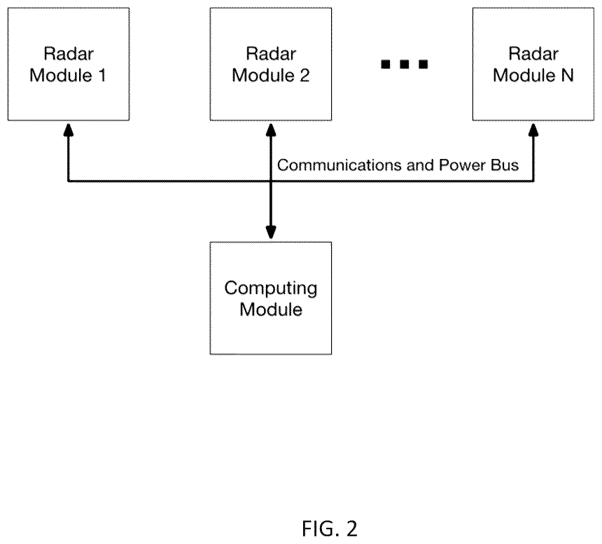

FIG. 2 depicts an example of a FMCW system that coordinates multiple radar modules that are attached to a single object (piece of stationary equipment) or single piece of mobile equipment at different locations. Multiple radar modules attached to a single device is also depicted in FIG. 1 described above. The computing module may be configured to process and analyze data from each of the radar modules and in this way, provide information about the equipment or object to an operator or centralized location using, for example, a standard wired or wireless network. The computing module may further be configured to communicate with other remote computing modules on other pieces of equipment or objects using the FMCW radar signals generated and received by the radar modules thus allowing operators to understand the operation and orientation of multiple objects or pieces of equipment in the field, e.g., relative to each other or a common origin. The computing module may include different modules, units, or components such as a processing unit and a memory.

The processing unit may be configured to process signals from the radar modules. The processing unit may be or include a central processing unit (CPU), a graphics processing unit (GPU), or both. The processing unit may be a component in a variety of systems. For example, the processing unit may be part of a standard personal computer or a workstation. The processing unit may be one or more general processors, digital signal processors, specifically configured processors, application specific integrated circuits, field programmable gate arrays, servers, networks, digital circuits, analog circuits, combinations thereof, or other now known or later developed devices for analyzing and processing data. The processing unit may implement a software program, such as code generated manually (i.e., programmed).

The processing unit may include a memory that can communicate via a bus. The memory may be a main memory, a static memory, or a dynamic memory. The memory may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, and the like. In one embodiment, the memory includes a cache or random-access memory for the processing unit. In alternative embodiments, the memory is separate from the processing unit, such as a cache memory of a processor, the system memory, or other memory. The memory may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory is operable to store instructions executable by the processing unit. The functions, acts or tasks illustrated in the figures or described herein may be performed by the programmed processing unit executing the instructions stored in the memory. The functions, acts or tasks are independent of the particular type of instructions set, storage media, processor or processing strategy and may be performed by software, hardware, integrated circuits, firmware, micro-code, and the like, operating alone or in combination. Likewise, processing strategies may include multiprocessing, multitasking, parallel processing, and the like.

The processing unit may further include a display unit, such as a liquid crystal display (LCD), an organic light emitting diode (OLED), a flat panel display, a solid-state display, a cathode ray tube (CRT), a projector, a printer or other now known or later developed display device for outputting determined information. The display may act as an interface for the user to see the functioning of the processing unit, or specifically as an interface with the software stored in the memory.

Additionally, the processing unit may include an input device configured to allow a user to interact with. The input device may be a number pad, a keyboard, or a cursor control device, such as a mouse, or a joystick, touch screen display, remote control, voice input, or any other device.

The processing unit may also include a disk or optical drive unit. The disk drive unit may include a computer-readable medium in which one or more sets of instructions, e.g., software, can be embedded. Further, the instructions may embody one or more of the methods or logic as described herein. In a particular embodiment, the instructions may reside completely, or at least partially, within the memory and/or within the processing unit. The memory and the processing unit also may include computer-readable media as discussed herein.

The present disclosure contemplates a computer-readable medium that includes instructions or receives and executes instructions responsive to a propagated signal, so that a device connected to a network can communicate voice, video, audio, images, or any other data over the network. Further, the instructions may be transmitted or received over the network via a communication interface. The communication interface may be a part of the processing unit or may be a separate component. The communication interface may be created in software or may be a physical connection in hardware. The communication interface is configured to connect with a network, external media, the display, or any other components, or combinations thereof. The connection with the network may be a physical connection, such as a wired Ethernet connection or may be established wirelessly. Likewise, the additional connections with other components of the system may be physical connections or may be established wirelessly.

The network may include wired networks, wireless networks, or combinations thereof. The wireless network may be a cellular telephone network, an 802.11, 802.16, 802.20, or WiMAX network. Further, the network may be a public network, such as the Internet, a private network, such as an intranet, or combinations thereof, and may utilize a variety of networking protocols now available or later developed including, but not limited to, TCP/IP based networking protocols.

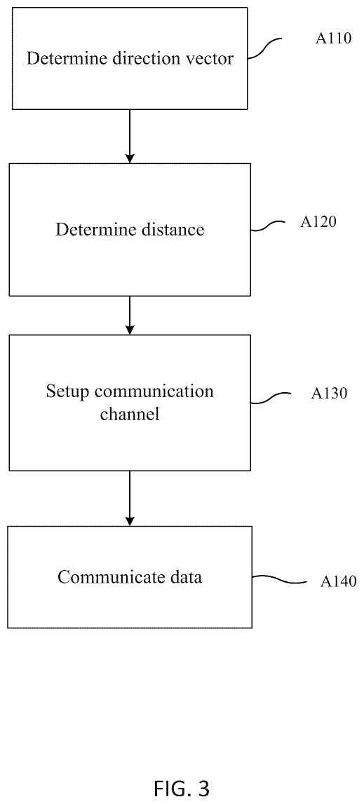

In an example operation of a system including at least two different FMCW systems, when two of the different FMCW systems are located such that, they are within each other's sensing field of view, they are then able to receive one another's transmitted signals, including the chirp signals. The chirp signals are processed and analyzed to identify a distance, direction, and orientation to another device. The distance, direction, and orientation may be used to setup a communication channel to the other device that uses the chirp signals to transmit data back and forth between the devices. FIG. 3 depicts a method for setting up and using a communication channel between two FMCW enabled devices.

At Act A110, a direction vector to the source of the opposite's transmitted signal can be determined using an array of two or more receive antennas by calculating the angle of arrival in either the azimuth or elevation planes, or both. Angular estimation is based on the observed phase shift between the signal received by at least two RX antennas. Because the antennas are at different locations, the distance between the antennas and the corresponding phase shift may be used to determine the angle of arrival. These antennas may be arranged in a grid with ½ wavelength center-to-center separation.

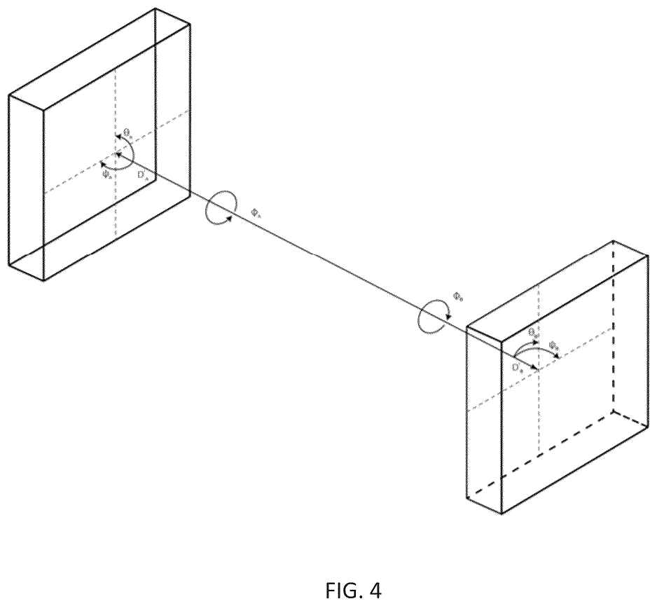

At Act A120, each receiving FMCW device may be configured to determine the distance to its opposite using FMCW ranging techniques, resulting in the location (distance and direction) to the opposite FMCW transmitting system, relative to the receiving device. By sharing this information between the devices, the relative direction and distance to, and orientation of, each device's opposite is then known to both. The rotation of the devices around the axis connecting the two devices relative to one another may also be determined through the use of multiple transmit antennas at different locations. Because the rotation of one device relative to the other causes an apparent motion of the transmit antennas based on the direction of rotation, the angle of arrival between antennas at the receiving end will be detected. FIG. 4 depicts a demonstration of each of measurements detectable with the system, including yaw, pitch, roll and distance.

An alternative method for determining the distance between devices is to have each device phase adjust its ramp signal to align the start of its chirp transmission to the start of the chirp it received. The advantage is that this method directly and unambiguously determines the distance between devices, rather than inferring it by making distance measurements in the direction corresponding to the device's transmission, relying on passive reflections from the device. This both improves reliability and accuracy. Each device can then determine the distance to its opposite using the same method it uses for ranging with a passive object, as time aligning transmission with reception duplicates the timing behavior of a passive reflector. The receiving device is able to make a relative phase measurement between the ramp signal received and the one it has transmitted by mixing the transmit and receive signals and measuring the frequency of the I/F signal. If the ramps are aligned, the transmit and receive frequencies are equal throughout the ramp and the mixed I/F signal will be 0 Hz (DC). If the I/F signal is non-zero, then a phase shift exists, and is proportional to this frequency. The I/F frequency may be high-pass filtered, in which case a minimum phase shift will need to be maintained. If this frequency is too large, a temporary adjustment to one of the parameters of the next transmit ramp can be made to compensate for this shift. Devices such as the IWR6843AOP do not directly support adjusting the phase of the transmit ramp, but other parameters, such as the idle time between ramps, the ramp repetition frequency, and the ramp duration are configurable. For example, the idle time between ramps can be temporarily adjusted and a new phase measurement can be made. Due to the I/F bandwidth limitation, phase aligning may be performed on a narrowband sweep channel used for communications, avoiding the searching process needed if operating instead on the wideband full sweep channel. Then this phase may be preserved when switching to a larger scan bandwidth. In alternative embodiment, direct phase control of the transmit ramp may be supported, rather than temporarily adjusting a parameter, which requires two time-controlled adjustments. The system may instead provide for a phase shift control function, whereby issuing the command directly advances or delays the phase of the chirp signal, simplifying and accelerating the synchronization process. Another method would be to provide for a phase resynchronization command, whereupon issuance the ramp signal restarts at a predetermined phase.

A simpler alternative to having the device phase align it transmit frequency ramp signal is for it to measure and communicate this phase to its opposite, which can then subtract this reported phase as an offset from its own phase measurement. This avoids requiring precise control of the phase and needing to continually adjust it. When using complex demodulation and sampling, the demodulation operation functions as a one-way frequency shift (negative or positive) of the received signal by the value of the transmitted frequency (the transmitted frequency functions as the demodulator's local oscillator in an FMCW system), whereas a real demodulator causes a two-way shift (both negative and positive). If a negative frequency shift is used, received frequencies higher than the transmitted frequency (the upper sideband) will result in positive I/F frequencies, and received frequencies lower than the transmitted frequency (the lower sideband) will result in negative I/F frequencies. If a positive frequency shift is used instead, the I/F is mirrored as the polarity of the demodulated I/F frequencies are reversed, and frequencies in the upper sideband will result in negative I/F frequencies and frequencies in the lower sideband will result in positive I/F frequencies. With a real demodulator, both positive and negative copies of the I/F frequency components will result. A phase shift between the transmit and receive frequency ramps results in an I/F signal of either positive or negative frequency, or both (for real sampling and demodulation), depending on which ramp is leading and which is lagging, and whether the frequency shift is positive or negative, or both (for real sampling and demodulation). The embodiments described throughout assume a positive slope ramp for both real and complex sampling and demodulation, and a negative frequency shift for complex sampling and demodulation but any combination of these may be selected with the only effect being the polarity of the demodulated I/F frequencies. Using a negative frequency ramp is equivalent to reversing which ramp is leading and which is lagging with respect to the positive slope case. In the case that the received (positive slope) frequency ramp is leading the transmitted (positive slope) ramp, the received frequency will be higher than the transmitted frequency, so the resulting I/F will be a positive frequency (assuming a negative frequency shift), and if lagging, negative.

This allows for direct determination of the magnitude and sign of the required phase adjustment. However, when using real demodulation and sampling, the frequency of the I/F signal is both positive and negative, and proportional to the phase shift between the transmit and the receive frequency ramps so does not indicate which signal is leading and which signal is lagging. One method of resolving this ambiguity is to have the receiving device perform a phase adjustment of its ramp signal and determine whether the I/F frequency increased or decreased. If a phase delay of the receiver's transmit ramp results in an increase in the I/F frequency, then the delay must have increased the time separation between the two ramp signals (moved the ramps further apart in time) as the difference in frequency between the ramps increased, so it follows that the receiver's transmit ramp was lagging the received ramp. Conversely, if a phase delay of the receiver's transmit ramp results in a decrease in the I/F frequency, the difference in frequency between the ramps decreased so it follows that the receiver's transmit ramp was leading the received ramp. If a phase advancement were used instead, an increase in frequency would indicate the receiver's transmit ramp is leading and a decrease would indicate that it's lagging. Performing this measurement may require coordination between the two devices, so that they are not concurrently making this adjustment. This coordination may be performed via the communications channel. Due to I/F bandwidth limitations, this modified phase aligning method may be performed on a narrowband sweep channel used for communications rather than the full sweep channel to ensure the demodulated signal is in band. Then this phase may be preserved when switching to a larger scan bandwidth. Also, the I/F bandwidth limitation limits the absolute phase difference that can be measured and communicated, so the phases must be aligned enough such that there is never more than the anti-aliasing bandwidth separation between the two.

This technique may be generalized through complex sampling techniques. If each device transmits a chirp and receives a chirp overlapping in time, complex frequency measurements from both devices may be combined to unambiguously measure the distance between the two devices. This is independent of the relative phase, provided the I/F signal is within the bandwidth of the receiver. In the case of the IWR6843AOP, this I/F upper bandwidth is 10 MHz, so the chirps must be sufficiently overlapped such that the difference in frequencies between the transmit and receive chirps is less than or equal to 10 MHz. This alignment may be accommodated by having one side temporarily use a fixed frequency for demodulation, where that frequency is within the sweep range of the received signal. This will cause a portion of the received chirp to be in-band, received as a chirp signal rather than a constant frequency, as the local oscillator used for demodulation is of fixed frequency rather than a chirp. The detection of this demodulated chirp, such as through cross correlation with a chirp basis function, may then be used to extract the timing of the received chirp by prior knowledge of the starting frequency of the received chirp and the fixed demodulation frequency. Further, the frequency slope of the I/F chirp will be equal to the transmitted chirp's slope, as the fixed demodulation causes a fixed frequency offset without changing the chirp's frequency slope. If the demodulator's frequency slope is non-zero, this slope is subtracted from the received chirp's slope, changing the slope of the I/F chirp. By utilizing this property, the receiving device may increase the magnitude of its slope to something non-zero, in order to decrease the resulting slope of the I/F chirp. Because this increases the time the signal takes to sweep the I/F bandwidth, it causes the received signal to remain within the I/F bandwidth for a longer duration of time. This simplifies detection and increases the resolution of the measured slope due to the increase in available digital samples. This slope may be measured by the receiving device, accounting for the demodulation chirp's slope, and replicated in its own chirp transmissions as a way to match the frequency slope between devices. The slopes may also be preconfigured to fixed values, which may or may not be equal to one another. Further, the chosen slope may, itself, be used to communicate information, for example the identity of the transmitting machine, such that the receiving device may determine the identity of the received signal by measuring this slope. If both devices transmit with a different slope, either the lower or higher slope or another predefined slope may instead be standardized for use by both devices if a match in slope is required to allow synchronization of the chirps between the two devices, to facilitate communications between the devices. In the case that the demodulation frequency is equal to the starting frequency, the beginning of the chirp is detected, with a small error as the high-pass corner within the I/F bandwidth requires a minimum frequency difference before it is detected. Once this timing is extracted, the receiver may then use a chirp signal with the extracted timing to fully detect and analyze the receive chirp. The slope used for device identification and discovery may be different than that used during data communications. For example, each device may use a unique slope to identify itself when not in communication with another device, but transition to another slope that may or may not be common to all communicating devices in the network. In-range communicating pairs may operate concurrently, provided their chirps are separated by more than the I/F bandwidth (e.g., 10 MHz). This is because chirps received more than the I/F bandwidth away from the local chirp are filtered by the I/F signal chain. The following paragraphs describe how to use the received chirps from both devices to extract the range between the two.

In the case that each device transmits the same chirp at the same time, each device will detect an I/F frequency proportional to the propagation delay between the devices. This is because for each device the received signal is delayed by the propagation delay with respect to the transmitted signal. This causes the difference in the transmit and receive frequencies to be directly proportional to this delay, so each device makes the same frequency measurement, from which the distance may be calculated. Because each device's transmit frequency is leading in time with respect to the received, the received frequency will be lower than the transmit and will be located in the lower sideband and will demodulate as a negative frequency. The average of these two frequencies may be used to determine the distance between the devices.

Another case is where device A transmits first, and device B transmits at the moment that device A's signal arrives, emulating a reflection from device B. In this case, device B will measure no I/F frequency, as there is no frequency difference between its transmit and receive signal. Device A will receive a frequency lower than its transmit based on the round-trip time (twice that of the previous case) and will again be in the lower sideband, demodulating as a negative frequency. The average of these two frequencies may then be used to determine the distance. The analysis is equivalent if devices A and B are switched.

Another case is where device A transmits first, and device B transmits before device A's signal arrives. In this case, device B will receive a frequency lower than its transmit frequency based on the difference in time between when it begins transmitting and when the signal is received (td1). As this signal is in the lower sideband, it will demodulate as a negative frequency. Device A will receive a frequency lower than its transmit frequency based on the round-trip time minus td1, and will also be in the lower sideband, demodulating as a negative frequency. The average of these two frequencies may then be used to determine the distance. The analysis is equivalent if devices A and B are switched.

Another case is where device A transmits first, and device B transmits after device A's signal arrives. In this case, device B will receive a frequency higher than its transmit frequency based on the time between when the received signal arrives and when it begins transmitting (td2). As the received signal is higher than the transmitted frequency, it will be in the upper sideband and demodulate to a positive frequency. Device A will receive a frequency lower than its transmit frequency based on the round-trip time plus td2, which is in the lower sideband and demodulates as a negative frequency. As the two frequencies seen at each end are of different signs, the average may be used to determine the distance. This analysis is equivalent if devices A and B are switched.

In each of these cases, and in general, the distance may be found by measuring and averaging the two frequencies, provided the frequencies have both a magnitude and sign. This may be accommodated with complex sampling, via in-phase and quadrature demodulation. As this technique functions independently of the alignment between the phases between each signal, it simplifies the synchronization process, requiring only enough overlap such that the I/F signal is in-band.

Referring back to FIG. 3, at Act A130, the transmit signals are used to send data, rather than simply performing scans. Because the chirp signal is defined by a number of characteristics, such as chirp rate, frequency range and ramp rate, different/modified chirp signals can be used to send different symbols or other information-carrying signals, where those symbols/signals represent different pieces of data/information. For example, a chirp signal could be used to send one or more bits, or other types of data such as the identity of the object transmitting the signal. The receiving FMCW device, according to the disclosed embodiments, can then detect these various chirp signals to receive and decode the transmitted data.

At act A140, the devices communicate data with one another using the set-up communications channel. Various modulation techniques such as binary phase modulation (BPM) may be used to send data, where the phase of the transmitted carrier is modulated by a phase of either 0 or 180 degrees. BPM is supported on some FMCW devices, such as the IWR6843AOP, not for sending data but rather as a way to support beamforming with multiple transmit antennas from the same device. By, instead, or in addition thereto, using this phase control as well as different chirp signals to encode data, the effective bandwidth of the channel can be increased, as there are now two phase-variants of each chirp available for data transmission. Finer control over the phase and amplitude allows for expanded bandwidth using methods such as quadrature amplitude modulation (QAM). The device's I/F may be bandlimited with a low-pass anti-aliasing filter and a high-pass filter for A/C coupling. This limits the phase shift between the transmit and receive sweep ramps that will result in a measurable I/F, as the I/F frequency is equal to the difference in transmit and receive frequencies. If the difference in frequencies is too high, the anti-aliasing filter will reject it. If the difference it too low, the high-pass filter will reject it. The IWR6843AOP has a maximum I/F bandwidth of 10 MHz, and a high-pass filter cut-off of 375 kHz. In this case the receiver must adjust the phase of its ramp until it is within 10 MHz of the received sweep, but not closer than 375 kHz, so that the I/F signal is in band. Reducing the sweep bandwidth by reducing the slope and/or duration of the chirp simplifies phase locking as the range of possible frequencies to track is reduced, at the expense of ranging accuracy, as ranging accuracy increases with increased sweep bandwidth in an FMCW system. In an alternative embodiment, the I/F bandwidth may be expanded toward 0 Hz (DC), which would allow for closer frequency-tracking between devices, and expansion to DC would allow exact frequency-tracking; extending the upper range would increase the range of allowable phase mismatch between the ramps transmitted by each device. This tracking may be further improved through the use of dedicated hardware, such as a phase-locked-loop (PLL). PLLs are typically constructed with a voltage-controlled oscillator (VCO), where the phase/frequency error between the VCO output and the input signal controls the VCO frequency. If the I/F signal is used as the input to a PLL with sufficient loop bandwidth to track the chirp rate, the PLL's VCO output signal will be a synthesized copy of the dominant (largest magnitude) frequency component of the received I/F signal. Therefore, the VCO control voltage may be utilized as a proxy for the dominant instantaneous I/F frequency. If this signal is summed with the ramp generator output used by the FMCW system, and this summed signal is used to control the transmit oscillator, the transmit frequency will be locked to the receive signal. It may be necessary to add some DC offset to the transmit control signal to prevent exact tracking, due to the described I/F high-pass cut-off. However, once the devices have locked using the reduced sweep bandwidth as described above, they may exchange chirp phase alignment data (the chirp phase offset measured by each device) using a communications channel and transition to a high sweep bandwidth and retain lock. It may also be important for the devices to use precision oscillators to avoid frequency drift. Temperature-compensated crystal oscillators (TCXOs) are available at less than 1 ppm tolerance, which is stable enough that the drift from sweep to sweep is small. Alternatively, a PLL could be used to synchronize the clocks but may introduce additional complexity. The sweep bandwidth, which is the range of frequencies swept, may be reduced to limit the possible frequency difference between devices as the range of possible frequencies is necessarily reduced, easing the search for the optimal phase.

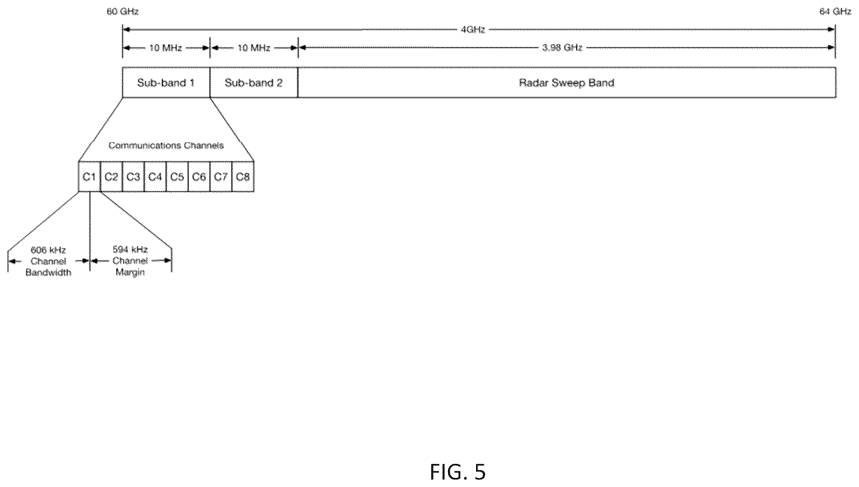

The FMCW device may be used to create a carrier sense multiple access with collision detection (CSMA/CD) communications network. When a device is receiving, it uses a predefined chirp, starting at a predefined frequency (fr), which it transmits at minimal power or not at all. This chirp is used to demodulate the received signal. When a device transmits, it transmits the equivalent duration and slope chirp, but at a different starting frequency (fr) than when in receive mode and its phase and/or amplitude can be modulated to send data. For any device receiving the transmitted signal, it will be demodulated to a frequency equal to the difference between the frequencies, which will have some uncertainty due to the relative phase shifts of the ramps. This phase shift may be adjusted such that the received signal is demodulated to a minimum I/F frequency. This alignment can be achieved by having the receiver's ramp phase adjusted such that the time duration of the I/F signal is maximized, as there is idle time between chirps. This represents the phase of maximum overlap between the two ramps. The difference between these frequencies must be higher than the high-pass cut-off and lower than the anti-aliasing cut-off, and the difference between these represents a sub-band which may be divided into multiple channels. Because any received signal more than the anti-aliasing bandwidth away from the receive mode chirp is filtered, other sub-bands used for data transmission, or radar sweeps, can co-exist, provided they use different frequencies. The chirp bandwidth determines the amount of bandwidth used for each channel, so the smaller the chirp bandwidth the more channels are able to coexist within the sub-band, with different devices using different transmit channels within the band. These channels may be preassigned or assigned on an ad-hoc basis. The arrangement allows a single device to receive data from multiple channels at once while in receive mode. However, when transmitting, the received signal is demodulated based on the transmit mode frequencies instead of the receive mode frequencies, which shifts the I/F signal down to lower frequencies. Many of these received frequencies are recoverable, but the signal received from another transmitter X Hz above the transmitter's frequency will demodulate to the same frequency as a channel X Hz below the transmitter's frequency, causing them to interfere with each other. While this can make data reception challenging while transmitting, it does allow for the detection of other transmitters, and can be used as a collision detection mechanism. A protocol can therefore be based on a single active transmitter, as any transmitter is able to detect the transmission from another transmitter, even if the data is corrupted, and perform a randomized exponential back-off mechanism, similar to that used by Ethernet. In an example, the IWR6843AOP supports a frequency range of 60 to 64 GHz. In an example frequency spectrum allocation, this band is divided into two 10 MHz sub-bands from 60 GHz to 60.01 GHz, and from 60.01 GHz to 60.02 GHz. These sub-bands are further divided into eight, 1.25 MHz channels, and the radar sweep band operates from 60.02 GHz to 64 GHz. This represents a sweep bandwidth reduction of 0.5% in comparison to 4 GHz, which reduces the ranging accuracy by this same small percentage. These bands can be arbitrarily chosen, and a single 10 MHz sub-band would restrict the radar sweep band by 0.25%. Though the sub-bands may be located anywhere in the spectrum, it may be advantageous to place them at the boundaries of the entire allowable spectrum, to avoid fragmentation of the sweep bandwidth. In an example, the IWR6843AOP supports a minimum chirp slope of 50 kHz/microsecond, and a minimum chirp duration of 12.12 us, representing a nominal bandwidth of 606 kHz. The 1.25 MHz channel bandwidth is roughly twice the signal bandwidth, providing margin between channels approximately equal to the signal bandwidth. FIG. 5 depicts this example allocation. The signal spectrum may be located anywhere within the channel but is shown beginning at the lower range of the channel.

In an embodiment, the devices use a standard demodulator and sampler, and as such, non-concurrent sweeps may be used for transmit and receive. This is because the resulting demodulated I/F has a spectrum shifted such that DC corresponds to the transmit frequency, received channels lower than the transmit frequency have negative frequencies and received channels higher than the transmit frequency have positive frequencies. If the negative frequency and positive frequency signals overlap in frequency magnitude, they will combine and destroy the data contained in both channels. This is because a real-valued signal cannot separate positive and negative frequencies, as no directionality to the signal frequency is available. A complex baseband architecture avoids this problem by using both an in-phase and quadrature demodulator, sampling each resulting I/F signal, and treating one I/F signal as the real component and the other I/F signal as the imaginary component of a complex signal. Unlike a real signal, where positive and negative frequencies are indistinguishable, a complex frequency allows for the separation of positive and negative frequencies. This is because a complex positive frequency can be represented by a counter-clockwise rotating complex exponential, or phasor, and a complex negative frequency can be represented by a clockwise rotating phasor. Because negative and positive frequencies may be separated with a complex baseband architecture, it allows for concurrent transmit and receive sweeps. Such an architecture may be supported in devices such as the IWR6843AOP, but for a different purpose. In typical FMCW systems, if the transmitted chirp is of increasing frequency, the reflected (delayed) signal frequency will be lower than that transmitted, so will be located in the lower sideband. If the chirp is of decreasing frequency, the reflected signal frequency will be higher than that transmitted, so will be located in the upper sideband. Because FMCW radar chirps generally chirp in one direction at a time (increasing or decreasing), only one sideband contains information. However, a standard mixer or demodulator folds both sidebands into the I/F band, so the noise power both in the upper and lower sidebands combine, decreasing the signal to noise ratio (SNR). Because the received radar signal exists in only the upper or lower sideband, the demodulated signal frequency will be only negative or positive, and the accompanying noise will demodulate to only negative or positive frequencies. With a real signal, positive and negative frequencies are indistinguishable, so the positive and negative frequency noise combine. The ability to separate positive and negative frequencies results in up to a 3 dB increase in SNR, and, for example, the IWR6843 employs a complex baseband architecture for this purpose of noise reduction. By using complex sampling for both purposes, it allows the bandwidth above the transmit frequency to be separable from the bandwidth below and maximizes SNR. The FMCW system may then be used to a transmit a chirp to send data and concurrently use that signal to demodulate data received from any channel within the sub-band. Because the transmit signal may be used to directly demodulate the received signal, any modulation of the transmit signal may also modulate the receive signal. In this case, successful data reception will depend on tracking how the transmit signal was specifically modulated in order to successfully receive data. The transmitted signal may be modulated by phase, frequency, amplitude, or some combination thereof. The result is multi-channel full-multiplex communications, provided each device transmits on a unique channel.

Using the described communications network, devices are able to coordinate their sensing transmission times to minimize interference when performing sensing measurements. Because the communications channel can be frequency separated from the sensing band as described above, scans and data communications may operate concurrently across multiple devices, provided the scan does not sweep through the communications band. This allows devices to coordinate in real time, so that only one device performs a scan at any one time. If the full scan bandwidth is desired, including the communications band, this may be coordinated between devices such that all data transmissions cease so as to allow for a full scan.

As this generalized complex sampling-based approach requires averaging the frequency measurement between each device, some mechanism is needed for communicating these measurements between devices or to another system. This may occur via a separate communications channel, wired or wireless, or may use the FMCW system itself. One method for communications from one device to the next is to use amplitude and/or phase modulation of the chirp signals. If phase is used, each device may then transmit a sequence of phase-modulated chirps within a frame, with one of those chirps containing a reference phase so that the difference in the phase between each chirp and the reference phase indicates the data being sent. The phase may be controlled with different resolution, to change the amount of data sent with each chirp. These phases are generally spaced to maximize the distance between different phases, maximizing noise immunity, and the number of bits transmitted in a chirp is equal to the binary logarithm of the number of supported phases. Two different phases (bi-phase) supports one bit per chirp, four phases (quadrature phase) support two bits, eight phases support three bits, etc. For example, the IWR6843AOP supports 6-bit phase control, or 64 phases, allowing 6 bits per chirp. Because a range measurement may be performed for each chirp and the data capacity of each chirp is limited, multiple chirps may need to be transmitted to communicate a frequency measurement. This limits the ranging update rate to some fraction of the chirp rate, so the communicated measurement may be an aggregate of the measurements from multiple chirps, such as by using a moving average.

A novel way of communicating this frequency measurement is by changing the sweep frequency bounds used by the chirp but leaving the frequency slope constant. This method allows the measured frequency to be communicated within a single chirp, significantly increasing the ranging update rate. If each device makes an initial frequency measurement via complex sampling, and subsequently shifts its transmit frequency sweep range by this same measured amount and polarity, it will cancel the frequency shift detected. This is because it changes the demodulation frequency to align in frequency with the receive frequency, demodulating that frequency to 0 Hz or DC. If the initial demodulated I/F is a positive frequency, shifting the chirp up by this same frequency will cause it to demodulate to DC; if the initial demodulated I/F is a negative frequency, shifting the chirp down by this same frequency will cause it to demodulate to DC. Further, by shifting (offsetting) a device's transmit chirp by the previously measured amount so as to null out its I/F to DC, its opposite device will see a change in its received I/F equal to that offset, thus communicating the frequency measurement information to the opposite device via that frequency change with a single chirp. Each device may perform this function concurrently, by shifting its chirp by the offset required to null the difference between the currently-received I/F frequency and the currently transmitted offset. Without first subtracting the current offset from the received I/F frequency, each device will continually attempt to null the received I/F frequency, and the system will not be stable. Accounting for the transmitted offset allows each device to measure a residual (non-null) I/F frequency, which represents the measurement being communicated by the other device. Each device may then average this measurement with its currently transmitted offset to determine the range between the two devices.

If each device has an independent chirp starting frequency and chirp timing and adjusts its starting frequency with an offset to communicate information, the math describing this technique may be generalized. The start frequency fsa and fs_{b}, are the starting frequencies of device A and B, respectively. The chirp slope, a_{f}, is the linear increase in frequency per unit time for each device's chirp, typically measured in MHz/μs. fₐ is device A's starting frequency offset, f_{b} is device B's starting frequency offset, tₛ is the lagging time shift of device B's chirp relative to device A's chirp, t_{d} is the signal propagation delay between device A and device B, and K is an additional frequency adjustment used by both devices to avoid demodulating the receive signal to 0 Hz (DC), which is not supported by some I/F signal chains designed with a high-pass corner frequency (A/C coupled). If this adjustment is larger than this corner frequency, an I/F signal will be received.

Device A's transmit frequency may be represented as:

f_{Txa}=a_{f}t+fₛₐ+fₐ+K

Device B's transmit frequency may be represented as:

f_{Txb}=a_{f}(t−tₛ)+f_{sb}+f_{b}+K

f_{Txb}=a_{f}t−a_{f}tₛ+f_{sb}+f_{b}+K

Device A's receive frequency is device B's transmit frequency delayed by t_{d}:

f_{Rxa}=f_{Txb}(t−t_{d})

f_{Rxa}=a_{f}(t−t_{d})−a_{f}tₛ+f_{sb}+f_{b}+K

f_{Rxa}=a_{f}t_{d}−a_{f}tₛ+f_{sb}+f_{b}+K

Device B's receive frequency is device A's transmit frequency delayed by t_{d}:

f_{Rxb}=f_{Txa}(t−t_{d})

f_{Rxb}=a_{f}(t−t_{d})+fₛₐ+fₐ+K

f_{Rxb}=a_{f}t−a_{f}t_{d}+fₛa+fₐ+K

Device A's intermediate frequency is its receive frequency minus its transmit

frequency:

f_{IFa}=f_{Rxa}−f_{Txa}

f_{IFa}=a_{f}t−a_{f}t_{d}−a_{f}tₛ+f_{sb}+f_{b}+K−a_{f}t−fₛₐ−fₐ−K

f_{IFa}=f_{sb}−fₛₐ+f_{b}−fₐ−a_{f}tₛ−a_{f}t_{d}

Device B's intermediate frequency is its receive frequency minus its transmit

frequency:

f_{IFb}=f_{Rxb}−f_{Txb}

f_{IFb}=a_{f}t−a_{f}t_{d}+fₛₐ+fₐ+K−a_{f}t+a_{f}tₛ−f_{sb}−f_{b}−K

f_{IFb}=fₛₐ−f_{sb}+fₐ−f_{b}+a_{f}tₛ−a_{f}t_{d}

The difference between device B's I/F and device A's I/F (f_{IFb}−f_{IF}a) due to

the difference in the devices' start frequencies (fₛₐ−f_{sb}) and/or chirp start times (a_{f}tₛ) may be defined as follows:

fₛ=a_{f}tₛ+fₛₐ−f_{sb}

The decrease in each device's I/F frequency due to the propagation delay of

the received signal may be defined as follows:

f_{d}=a_{f}t_{d}

Using fₛ and f_{d}, we can simplify f_{IFa} and f_{IFb}.

f_{IFa}=f_{sb}−fₛₐ+f_{b}−fₐ−a_{f}tₛ−a_{f}t_{d}

f_{IFa}=f_{b}fₐ−a_{f}tₛ+f_{sb}fₛₐa_{f}t_{d}

f_{IFa}=fₐ+f_{b}−fₛ−f_{d}

f_{IFb}=fₛₐ−f_{sb}+fₐ−f_{b}+a_{f}tₛ−a_{f}t_{d}

f_{IFb}=fₐ−f_{b}+a_{f}tₛ+fₛₐ−f_{sb}−a_{f}t_{d}

f_{IFb}=fₐ−f_{b}+fₛ−f_{d}

f_{IFa}_{₀₀} and f_{IFb}_{₀₀} can be defined as the I/Fs seen by devices A and B when both

device A and device B use a starting frequency offset of zero:

fₐ=0

f_{b}=0

f_{IFb}_{₀₀}=fₛ−f_{d}

f_{IFb}_{₀₀}=fₛ−f_{d}

f_{IFa}_{₁₁} and f_{IFb}_{₀₀} can be defined as the I/Fs seen by devices A and B when

device A uses f_{IFa}_{₀₀}−K as its offset and device B uses f_{IFb}_{₀₀}−K as its offset, where K is an additional offset used to avoid demodulation below the high-pass cut-off:

fₐ=f_{IFa}_{₀₀}−K

f_{b}−f_{IFb}_{₀₀}−K

f_{IFa}_{₁₁}fₛ−f_{d}

f_{IFb}_{₁₁}=−fₛ−f_{d}

f_{IFa}_{₁₀} and f_{IFb}_{₀₁} can be defined as the I/Fs seen when device A uses an offset

equal to f_{IFa}_{₀₀}−K and device B uses an offset of zero:

fₐ=−fₛ−f_{d}−K

f_{b}=0

f_{IFa}_{₁₀}==K

f_{IFb}_{₀₁}=−2f_{d}−K

f_{IFa}_{₀₁}and f_{IFb}_{₁₀} can be defined as the I/Fs seen when device A uses an offset

equal to zero, and device B uses an offset equal to f_{IFb}_{₀₀}−K:

fₐ=0

f_{b}=−fₛ−f_{d}−K

f_{IFa}_{₀₁}−2f_{d}−K

f_{IFb}_{₁₀}=K

It may be observed that each device may combine its complementary I/F

frequencies (switching 1s to 0s and vice versa) in different ways to determine fₛ and f_{d}:

f_{IFa}_{₀₀}+f_{IFa}_{₁₁}=−2f_{d}

f_{IFa}_{₀₀}−f_{IFa}_{₁₁}=−2fₛ

f_{IFa}_{₀₁}+f_{IFa}_{₁₀}=−2f_{d}

f_{IFb}_{₀₀}+f_{IFb}_{₁₁}=2f_{d}

f_{IFb}_{₀₀}−f_{IFb}_{₁₁}=2fₛ

f_{IFb}_{₀₁}+f_{IFb}_{₁₀}=−2f_{d}

The combination of the non-complementary pairs may also be determined:

f_{IFa}_{₀₀}+f_{IFa}_{₀₁}=−fₛ−3f_{d}−K

f_{IFa}_{₁₁}+f_{IFa}_{₁₀}=fₛ−f_{d}+K

f_{IFa}_{₀₀}+f_{IFa}_{₁₀}=−fₛ−f_{d}+K

f_{IFa}_{₁₁}+f_{IFa}_{₀₁}=fₛ−3f_{d}−K

f_{IFb}_{₀₀}+f_{IFb}_{₀₁}=fₛ−3f_{d}−K

f_{IFb}_{₁₁}+f_{IFb}_{₁₀}=−fₛ−f_{d}+K

f_{IFb}_{₀₀}+f_{IFb}_{₁₀}=fₛ−fₐ+K

f_{IFb}_{₁₁}+f_{IFb}_{₀₁}=−fₛ−3f_{d}−K

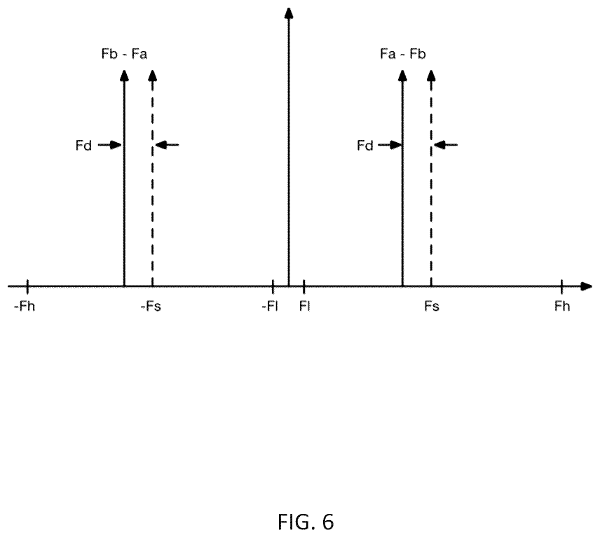

It may be observed that complementary pairs of the non-complementary sums may also be used to determine fₛ and f_{d}, as each I/F has a complementary match in the equations above. Further, once fₛ has been determined it stays constant other than some small shift due to relative clock drift between device A and device B. Additionally, fₛ may be adjusted to maximize the detectable f_{d} range. The non-offset received I/F is equal to −fₛ−f_{d} for device A and fₛ−f_{d} for device B. Because f_{d} moves away from DC in the negative spectrum and toward DC in the positive spectrum, the optimal value of fₛ is the average of the high-pass and low-pass cut-off frequencies of the I/F signal chain (fₕ and fₗ, respectively). For example, if the low-pass cut-off is 10 MHz and the high-pass cut-off 375 kHz, the optimal Fs is 5.1875 MHz. One device may adjust its chirp timing or starting frequency to achieve this, or both devices may make a portion of the desired timing and/or frequency change. FIG. 6 illustrates the location of these frequencies on a frequency spectrum plot. Device A's signals are located in the negative region of the spectrum and device B's are in the positive region, and fₛ is centered between fₗ and fₕ in both the negative and positive regions. The received frequencies are represented by f_{b}−fₐ for device A and fₐ−f_{b} for device B, and are both shifted to the left by f_{d}.

For both device A and device B, it may be observed that the average of different combinations of each device's I/F complementary pairs is −f_{d}. By utilizing this property and the property that the average of all combinations of each device's unique I/Fs is also −f_{d}, the offsets may be used to communicate data as well as to determine the range. Instead of transmitting only alternating frequency offsets, the offsets data may be used to transmit information. If the offsets are arranged as a DC-balanced sequence such as Manchester encoding, 8B/10B encoding, or 64B/66B encoding, the average of the frequencies measured for each device may be converted to a range measurement. This provides for a robust, frequency modulated communications link, providing both data and ranging information. The devices may choose to transmit alternating offsets as an idle state providing ranging information. Then if a device wishes to transmit data, it sends a different pattern of offsets, which are detected by the other device's receiver. If the two devices attempt to transmit data concurrently, it can be detected by monitoring the received data while transmitting.

If the frequency offset control signal follows a pattern such as Manchester encoding, then each device transmits frequencies in complementary pairs (complementary offsets) for each transmitted bit. Because the I/F frequency received by each device is the received frequency minus the transmitted frequency, the received I/F frequencies corresponding to the two frequencies that comprise each bit are also complementary pairs, provided that both sides are synchronized and transition in concert. Because fₛ and f_{d} may be determined through the addition and subtraction of complementary I/F pairs, and the frequency offset transmitted by each device is known to itself, the two different expected I/F frequencies corresponding to the two possible frequency offsets transmitted by the other device may be determined, and the expected frequency to which the measured frequency is closer indicates the frequency offset transmitted by the other device.

In an example, devices A and B may determine the frequency offset transmitted by the other device as follows:

fₐ, as determined by device B:

fₐ−f_{IFb}=f_{b}−fₛ+f_{d}

f_{b}, as determined by device A:

f_{b}=f_{IFa}+fₐ+fₛ+f_{d}

Because the range represents the physical distance between device A and device B, it may change relatively slowly with respect to the chirp repeat rate. This behavior may be utilized to further increase the channel bandwidth. If both fₛ and f_{d} are determined at the beginning, end, or some other location in a frame through one of the previously described techniques, the remaining chirps in the frame may be transmitted with a variety of frequency offsets, provided fₛ does not change (due to clock drift, etc.) by more than the detection resolution of the frequency. If device A and B wish to transmit concurrently, then each is able to vary its starting frequency offset by

$$\frac{{f}_{h} - {f}_{l}}{2} - {f}_{d} .$$

These shifts may be entirely in one direction from the starting direction or a combination of both directions, provided the magnitude and direction of allowable shifts is coordinated between devices. For instance, if fₐ is constrained to shifts in one direction (positive/negative) and utilizes the entire range, f_{b} is constrained to the same direction (positive/negative) and range. If fₐ is constrained to half the range in each direction, f_{b} will have the same constraints. If transmissions are not concurrent, then the available frequency range is doubled to fₕ−fₗ, as device A and B's frequency offsets are not combined. By utilizing the available frequencies for data transmission, the capacity of the bandwidth is increased by a factor of the binary logarithm of the number of available and detectable frequencies. For instance, if fₛ is optimally positioned at 5.1875 MHz, the midpoint between 375 kHz and 10 MHz, and the detectable frequency resolution is 2.5 kHz, corresponding to a chirp width of 400 microseconds, there are 1925 frequency offsets available for transmission when using concurrent transmissions (3850 when using non-concurrent transmissions), assuming f_{d} is zero. 10 bits requires 1024 distinct frequencies, leaving 901 as margin for f_{d}. A chirp slope of 10 MHz/microsecond translates to an f_{d} of approximately 10 kHz/foot of separation, assuming the signal travels at the speed of light. Each frequency bin is roughly 3 inches (75 mm), leaving approximately 225 feet of available propagation delay. This method may be combined with phase and amplitude modulation, further increasing the channel capacity.

In an embodiment, the distance between the two devices is determined by the phase delay of the carrier between the two devices. This may be determined by transmitting a signal from one device, demodulating it with the other device and measuring the phase of the I/F signal, repeating this process in the other direction, then determining the difference between the two measured phases. This provides a maximum range measurement equal to the carrier wavelength before it repeats. In the millimeter wavelength range, this range is therefore limited to millimeters which is often much shorter than the distances between the machines to which the devices are attached. However, this ambiguity may be resolved by repeating this process for two or more different frequency ranges, and using the frequency and phase data to determine the position, with the accuracy increasing as more frequency ranges are utilized.

Because the frequency offset method of communication may work in addition to any communication resulting from modulating the phase or amplitude, both techniques may be used in concert. Further, because the signal-to-noise ratio (SNR) determines the capacity of the channel when using phase and amplitude modulation and the SNR decreases with distance, the ranging measurements may be used to determine what the capacity of the channel is for phase and/or amplitude modulated data.

Because the range measurements are based on frequency measurements, the range resolution is limited by the frequency measurement resolution, which is defined by the FFT bin size. Unless a frequency is in the exact center of an FFT bin, there will be mismatch in how much of that signal is detected in adjacent bins. As this frequency shifts, it changes the relative weighting in the frequency bins. For example, if a frequency is at the midpoint between bins, it will be detected equally in both bins, and this ratio shifts as the frequency shifts. By utilizing this property, a small relative shift in frequency between device A and device B may be introduced, and the impact on the detected spectrum may be measured. By sweeping through many small changes and measuring the spectrum for each change, the detectable frequency resolution may be increased to the size of the frequency step. One method of processing the spectrum is to track the value of the frequency bin containing the maximum and track each adjacent frequency bin over a number of frequency offset changes. If the frequency is stepped from half a bin width lower to half a bin width higher in frequency, the frequency adjustment where the magnitude of the center bin divided by the sum of the magnitudes of the adjacent bins is maximized represents the frequency offset that optimally aligns the signal within the bin. This offset may then be subtracted from the frequency corresponding to the maximum bin with no offset, adding precision to the measurement equal to the frequency step amount. For example, the IWR6843 supports a start frequency resolution of 40.233 Hz. If a chirp slope of 10 MHz/microsecond is used, this frequency shift represents a time shift resolution of 4 picoseconds, which represents 1.2 mm of distance. The method of finding the optimum frequency offset could be a simple linear search, using repeated searches of increasing granularity, a binary search, or some other search algorithm. If the relative magnitudes of the adjacent bins are considered, then the direction of the search is known. This is because the adjacent bin with the lower magnitude represents the direction in which the frequency needs to shift in order to be centered in the bin. If the search begins by stepping a half bin of frequency in the direction indicated by the bin neighbors, followed by successive divisions of the frequency step by two in the required direction, the maximum will be rapidly found. A similar technique may also be used by slightly adjusting the frequency slope in the single-device case. Because the demodulated I/F frequency is proportional to the frequency slope, small changes in the slope will result in small changes in the I/F frequency. As this is effectively a change in gain, it results in geometric steps through the frequency bins, instead of linear steps as is the case with the dual-device case. Alternatively, interpolation techniques may be used to estimate the frequency rather than adjusting the signal to be located directly in the center of bin. This may involve linear interpolation between the center bin and its neighbors to derive an estimate, zero-padding the FFT to increases the frequency resolution (up-sample) through interpolation or using a chirp Z-transform to also increases the frequency resolution in the frequency band of interest through interpolation.

Further precision may be yielded from measuring the phase. If each device transmits its signal using a known phase, the phase received at each end relative to the known transmit phase can be used to represent a finer precision shift from an integer number of signal wavelengths. If the sweep starts at 60 GHz, this corresponds to a wavelength of 5 mm, so the signal's phase as a fraction of 2 pi radians represents the fraction of a 5 mm measurement window. However, because the phase repeats every 2 Pi radians, it is unable to indicate how many cycles of delay there are. However, because a measurement more precise than the 5 mm wavelength is available via the frequency stepping technique, the number of complete 5 mm wavelengths is known, and the phase measurement represents an incremental distance to be added to the distance represented by the number of complete wavelengths. For a 12-bit measurement of the phase, this represents a resolution of roughly 1.2 micrometers. It may be necessary to compensate for transmit and receive propagation delays through the electronics signal chain, as this will result in a phase shift. This may be supported through in-factory or in-field calibration.

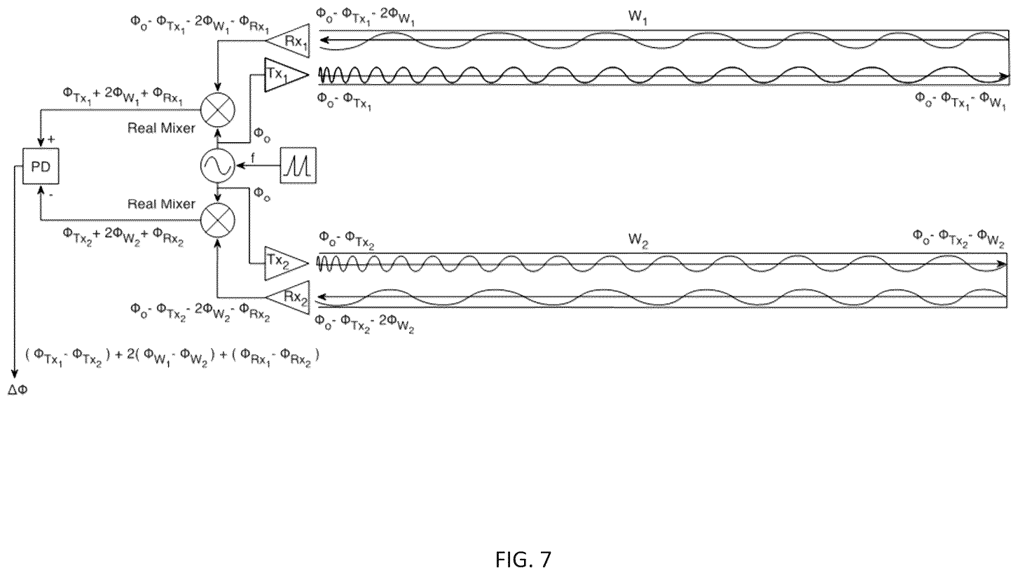

Further precision may be yielded from measuring the phase. If each device transmits its signal using a known phase, the phase received at each end relative to the known transmit phase can be used to represent a finer precision shift from an integer number of signal wavelengths. If the sweep starts at 60 GHz, this corresponds to a wavelength of 5 mm, so the signal's phase as a fraction of 2 pi radians represents the fraction of a 5 mm measurement window. However, because the phase repeats every 2 pi radians, it is unable to determine how many cycles of delay there are. However, because a measurement more precise than the 5 mm wavelength is available via the frequency stepping technique, the number of complete 5 mm wavelengths is known, and the phase measurement represents an incremental distance to be added to the distance represented by the number of complete wavelengths. For a 12-bit measurement of the phase, this represents a resolution of roughly 1.2 micrometers, which may be further increased through the averaging or filtering of repeated measurements. It may be necessary to compensate for transmit and receive propagation delays through the electronics signal chain, as this will result in a phase shift. This may be supported through in-factory or in-field calibration. These phase shifts may also be mitigated by performing differential distance measurements, so that the delays are subtracted between measurements. Any fixed offsets between channels may be treated as a baseline offset, leaving only the mismatch in sensitivity between channels causing measurement error. This allows for precise differential distance change measurements, used for applications such as strain gauges, extensometers, or measurements of the thermal coefficient of expansion of a material if temperature is also measured. FIG. 7 depicts an example of a precision differential distance measurement instrument based on this technique.

The above uses two channels of an FMCW system coupled into two different transmission media, shown as waveguides W1 and W2. They are shown as waveguides, but may be any transmission media for the waves to travel, including free space, or a transmission line such as coaxial cable, twin lead, ladder line, open wire line, etc. Free space and waveguides may be advantageous, as they avoid the use of lossy dielectrics, and do not conduct, which avoids the skin effect. Both dielectric losses and the skin effect cause a distance-dependent reduction of bandwidth and signal level, reducing system performance. Also, the propagation delay in free space or within a waveguide is very consistent, which may not be the case for dielectric materials. The system couples frequency chirps into both waveguides, where it is either reflected from the far end or routed back through a 180 degree turn. It may also loop back and forth multiple times to increase the effective distance between the devices and resulting sensitivity. It mixes the transmit chirp with the received chirp, and measures the phase of the resulting IF, using a hardware-based phase detector, or with digital signal processing techniques such as FFTs or time domain-based phase analysis. The chirps are generated with a phase of Φo, where they are processed by transmit signal chains one and two, delaying them by phases ΦTx1, and ΦTx2, respectively. Each signal propagates down its respective waveguide, W1 and W2, where they are delayed due to the propagation of the wave along the respective lengths by phases ΦW1, and ΦW2, respectively. Each signal then propagates back to the receivers, further delaying the signals by ΦW1, and ΦW2. These signals are then received, further delaying the signals by ΦRx1 and ΦRx2. The demodulation functions as a frequency and phase subtraction operation, subtracting the lower frequency from the higher one, resulting in a phase of ΦTx1+2ΦW1+ΦRx1 for channel one and a phase of ΦTx2+2ΦW2+ΦRx2 for channel two. If phase two is subtracted from phase one with a phase detector, either implemented in hardware or software, the resulting phase, ΔΦ, is (ΦTx1−ΦTx2)+2((W1−ΦW2)+((Rx1−ΦRx2). This example is using double sideband demodulation using a real mixer. If the system instead uses single sideband demodulation using an IQ mixer, the noise performance may be improved by 3 dB as only the noise in the upper or lower sideband is demodulated. This configuration is not able to measure the absolute length of the waveguide within a resolution greater than typical FMCW systems, but is effective for detecting small changes in length, for applications such as strain measurement.

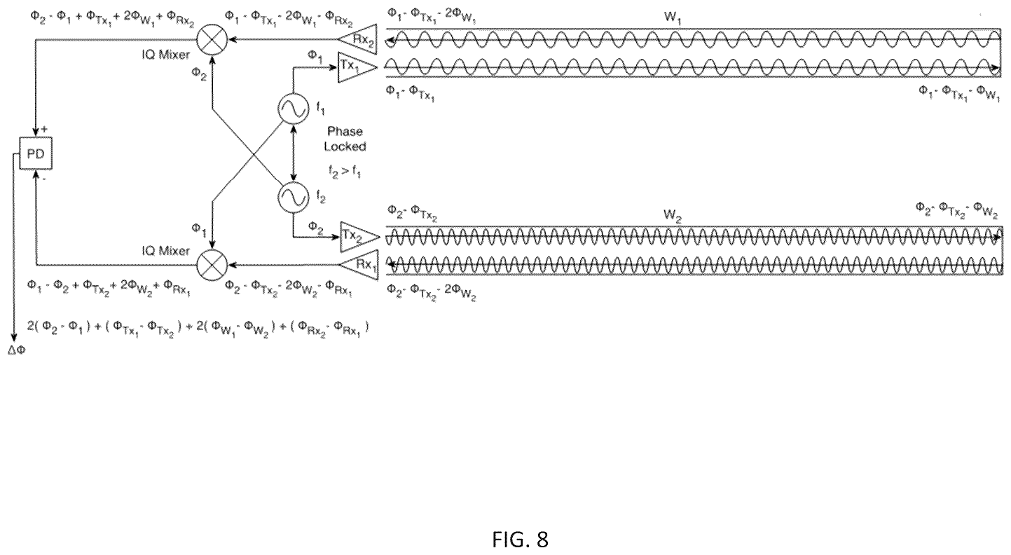

It may be observed that ΔΦ changes with relative changes between ΦTX2 and ΦTX1, ΦRX2 and ΦRX1 and ΦW2−ΦW1. If ΦTX2 and ΦTX1 are well-matched, and ΦRX2 and ΦRX1 are well matched, they may have an offset relative to one another, but will generally change together as a function of temperature, voltage or other operating condition. Any small imbalance in these delays may be characterized according to these operating conditions, so that conditions such as temperature and voltage may be monitored, and the results compensated. What remains is the difference in phase delay from each waveguide. If these waveguides are stretched or compressed, the system will detect the differential change in length between them. If one were installed at the top side of a bending beam and the other at the bottom, the degree of bending may be measured, as the top of the beam is in tension while the bottom is in compression, and vice versa. And because both waveguides are attached to the same beam, overall changes in length due to thermal expansion are common to both so the difference does not detect this. One waveguide may also be installed on the neutral axis of the beam. In this configuration, it continues to provide the cancellation of transmit and receive signal chain propagation delays and thermal expansion, but the resulting differential strain will be half as sensitive as the prior case. One channel may also be unattached to the beam, or internally looped back in the device, which provides for cancellation of transmit and receive signal chain propagation delays but does not compensate for thermal expansion. In this case, a high-precision temperature sensor may be used to monitor the temperature of the beam and waveguide (if used), and the strain compensated through knowledge of the coefficient of thermal expansion of the beam and waveguide materials. Further channels may be added, allowing for the monitoring of one or more additional strains, which may or may not be negatively correlated with one another, or for monitoring a reference strain. If the receive signal chain uses a high-pass filter, the waveguides will need to be a minimum length to ensure the difference in transmit and receive frequency is large enough to cause the demodulated I/F to be in band. FIG. 8 depicts another configuration which avoids this restriction through the use of two different transmit frequencies.

This configuration is similar to the first, but instead of transmitting a single chirp down each waveguide, two different frequencies may be selected. Because they can be independently chosen, they may be selected such that the demodulated I/F is in band, regardless of the waveguide length. If chirps are used in conjunction with the frequency-stepping technique, the absolute length of the waveguides may be measured with high accuracy. However, chirping is optional, as the difference in frequency may be directly selected. It may be possible to reduce the phase and amplitude noise by using a single frequency instead of sweeping. With a single transmitter, the frequency chirp is required, in order to cause sufficient difference between the transmit and receive frequencies such that the I/F is in band, which is why a minimum length is required. With the dual-frequency approach, this difference may be directly controlled, avoiding the need for a minimum length. Two frequencies, f1 and f2 are used, with synchronized phases Φ1 and Φ2, respectively, and are delayed by phases ΦTx1, and ΦTx2, respectively. Each signal propagates down its respective waveguide, W1 and W2, where they are delayed due to the propagation of the wave along the respective lengths by phases ΦW1, and ΦW2, respectively. Each signal then propagates back to the receivers, further delaying the signals by ΦW1, and ΦW2. These signals are then received by the other channel's receiver, further delaying the signals by ΦRx2 and ΦRx1. Each signal is then cross demodulated using IQ mixers, where the channel one is demodulated with channel two and vice versa. This cross demodulation allows for the mixing of two different frequencies, such that the received I/F will be in-band if the frequencies are chosen appropriately. IQ mixers are required to demodulate both the positive and negative frequencies in this configuration, caused by the cross demodulation. This results in a phase of Φ2−Φ1+ΦTx1+2ΦW1+ΦRx2 for channel one and a phase of Φ1−Φ2+ΦTx2+2ΦW2+ΦRx1 for channel two. If phase two is subtracted from phase one with a phase detector, either implemented in hardware or software, the resulting phase, ΔΦ, is 2(Φ2−(1)+(ΦTx1−ΦTx2)+2(ΦW1−ΦW2)+(ΦRx2−ΦRx1). The result is similar to the previous single-frequency configuration, except the polarity of the difference in receive signal chain phase delays is inverted due to the cross-connection between transmit and receive, and it is also sensitive to the offset between the starting phases of the two transmitters, Φ2 and Φ1.

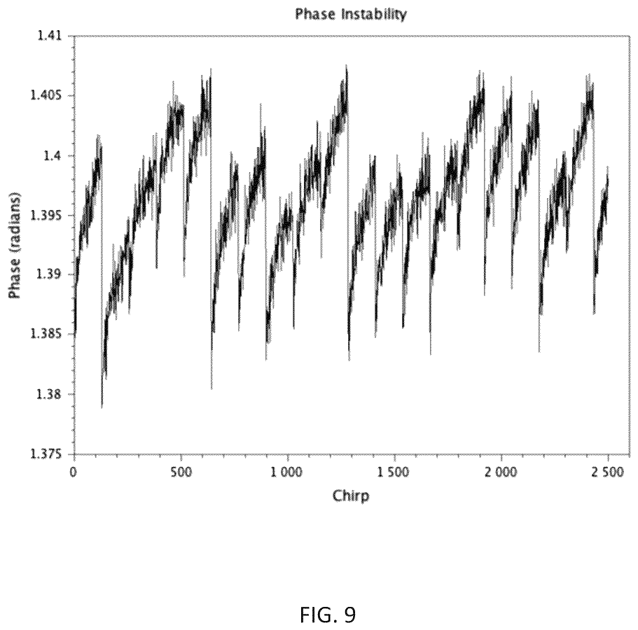

Another modification to the dual and single strain measurement systems described above is to introduce one or more reference signals corresponding to known locations on the waveguide, so that frequency or phase measurements may be performed relative to those locations. In addition to compensating for variability in delay in the transmit and receive signal paths, this approach may be used to compensate for any phase instability from chirp to chirp, caused by variability in chirp timing or due to other effects, as changes in the phase will be common to each measurement location. In the IWR6843AOP, the chirp phase instability may follow the example pattern shown in FIG. 9.

The reference locations on the waveguide may be created through introducing one or more impedance mismatches in the waveguide through geometry changes. Alternatively, if a delay is introduced between the transmitter/receiver and their respective antennas, and the antennas are located at the waveguide injection location, a signal corresponding to the waveguide injection location may be detected. This frequency component is received due to the direct coupling from the transmit antenna to the receive antenna. In typical FMCW ranging applications, this coupling is undesirable as it does not typically correspond to an object of interest and may saturate the receiver due to the relatively large signal level relative to remote objects. However, when using a waveguide, the reflected signal is of similar size due to the low attenuation of the waveguide. If the transmit and receive antennas are located close to the device, the signal delay between the transmitter and receiver is small and the demodulated I/F is low frequency and can be removed through the use of a high-pass filter. However, in this waveguide-based strain gauge application, it is desirable to see a frequency component corresponding to the waveguide injection point, so that the phase or frequency at both ends of the waveguide may be measured. In order to allow this component to be of sufficiently high frequency to pass through the high-pass filter, a delay between the transmitter/receiver and the antennas coupling to the waveguide may be introduced. This facilitates a frequency or phase measurement at the beginning and end of the waveguide used for the strain measurement. By measuring changes in frequency or phase at both ends, and the difference between the two, it removes the influence of any inter-channel variation, further improving the accuracy of the system. The transmitter and receiver for the FMCW device may be separated from the waveguide by another waveguide, coaxial cable, circuit board trace, or any other transmission line. One implementation is to use printed circuit board (PCB) traces to connect the transmitter and receiver to a pair of co-located antennas for coupling into the waveguide. When the transmitter sends a chirp, the receive antenna will receive it directly from the transmitter antenna at the point that it enters the waveguide and also when it returns from the end of the waveguide. If the connecting traces are of sufficient length, the delay will cause the signal received at the point of injection to be in-band, allowing for an accurate differential phase measurement, immune to variations in the transmit and receive signal path delays.

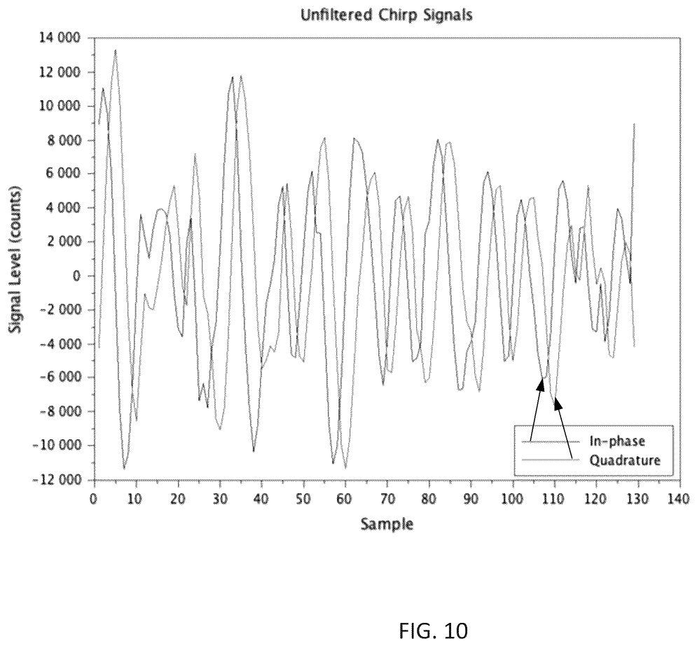

Another method for determining the frequency, phase or angle of the reference and measurement signal is to use in-phase and quadrature (I/Q) sampling. This allows the I/F angle to be determined on a sample-by-sample basis within each chirp, by computing the arc tangent of the ratio of the quadrature to in-phase sample values. Because the tangent repeats every pi radians, the angle may be unwrapped to produce a straight line, by adding an additional pi radians to the phase when the angle decreases rather than increases from sample to sample, assuming that the angle is increasing. If the angle is decreasing, the additional pi radians would be subtracted when the angle increases instead of decreasing. Each of the reference and measurement frequencies may be isolated through the use of digital filtering. These may be by linear phase filters, so that each frequency is delayed by the same amount. The per-sample angle of each of the signals may then be determined using the unwrapped arctan of the ratio of Q to I. FIG. 10 depicts a graph showing an example set of 128 I/Q samples from a demodulated chirp.

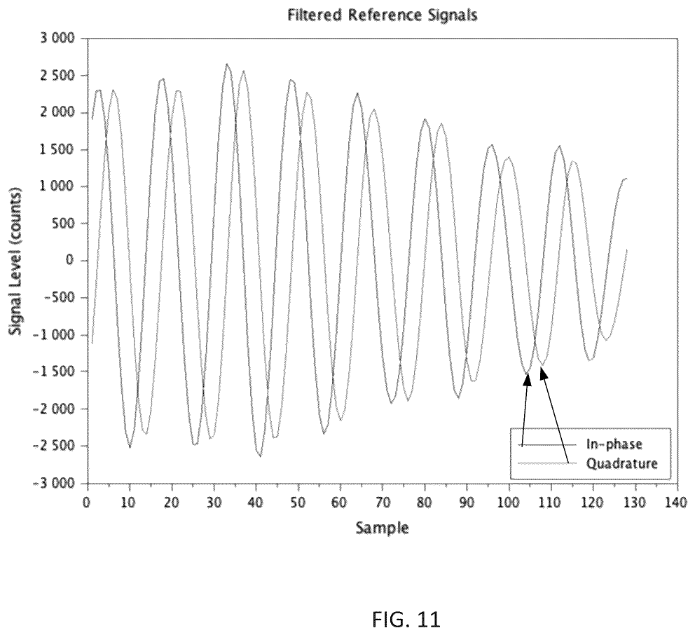

FIG. 11 depicts a graph showing the middle 128 samples from the filtered reference signal, extracted by using a 128-long finite-impulse-response (FIR), linear-phase filter, tuned to the nominal reference frequency.

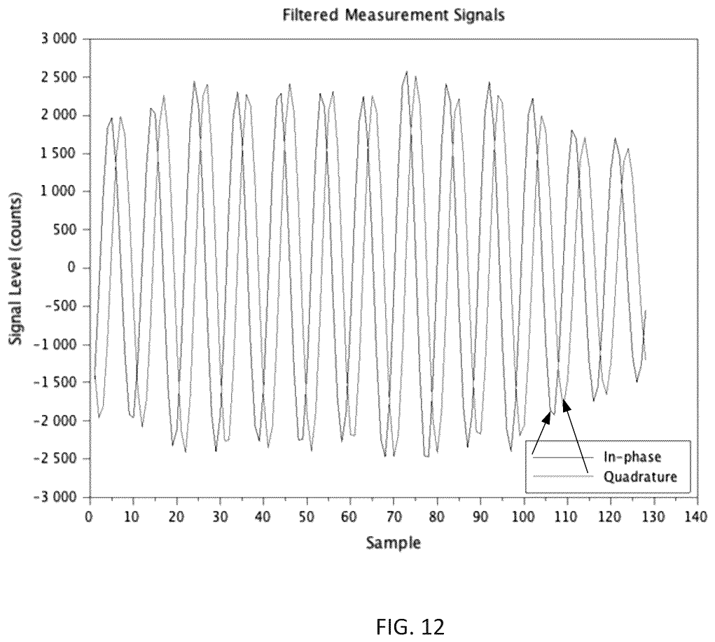

FIG. 12 depicts a graph showing the middle 128 samples from the filtered measurement signal, again extracted by using a 128-long FIR, linear-phase filter, tuned to the nominal measurement frequency.

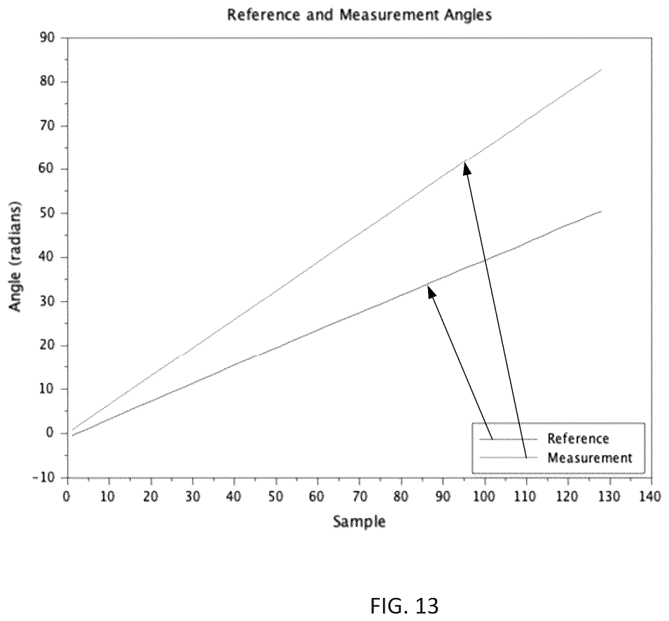

The instantaneous angle of each of these signals may be determined by calculating the unwrapped arc tangent of the ratio of the quadrature to the in-phase components, as shown in FIG. 13.

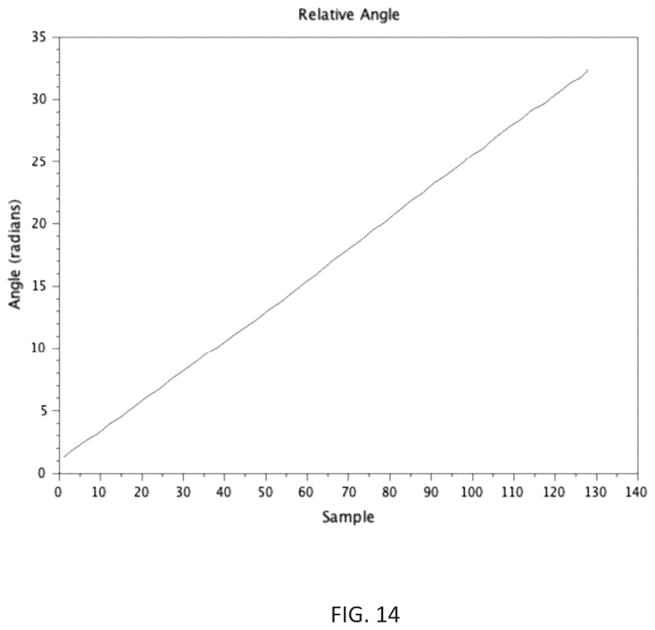

Because each signal is of constant frequency, the angle is a linear function of sample count. The slope of each line represents the frequency in radians per sample, and the vertical intercept represents the phase shift. Because the angle is measured using analog-to-digital converter (ADC) readings for each sample, the frequency can be measured with much greater resolution than when using an FFT. This is because the frequency resolution of an FFT is limited to integer frequency cycles fitting within the measurement window. Because the above method measures the angle with high precision on a per-sample basis, the frequency may be measured using the total angle swept over the samples within the chirp, which is not restricted to an integer number of cycles. The difference between these two lines represents the relative angle between the reference and measurement signals, as shown in FIG. 14.

The slope of the above graph represents the relative difference between the measurement and reference signals, and the vertical intercept represents the phase shift for the measurement window. For the above graph, the slope is approximately 0.246 radians/sample and the vertical intercept 0.79 radians. This data was captured using a chirp slope of 250 MHz/us and a sampling rate of 12.5 MSPS. The slope therefore translates to a frequency of 489.4 kHz (0.246×12.5e6/2/pi). This represents a round-trip-delay of 1.958 ns based on the chirp slope rate (489.4e3/250e6×1e−6), or a relative distance of 0.294 m (3e8×1.958e×9/2) between the reference and measurement locations on the waveguide. Small changes in distance may be determined with more sensitivity by measuring small changes in the vertical intercept, where the change in distance is the change in phase divided by 2 pi, multiplied by the radar signal wavelength, divided by two for the round trip. The distance may be measured absolutely through the frequency measurement, and changes from this distance measured through changes in phase. Further, by averaging repeated measurements, the accuracy of both the frequency and phase measurements may be increased, assuming the distance between the reference and measurement locations changes slowly with respect to the averaging window. The relationship between the sensitivity of frequency and the sensitivity of phase to changes in length is affected by the chirp slope, or frequency acceleration, a_f. As frequency represents a cumulative phase rotation over a period of time, a change in frequency translates into a change in cumulative phase rotation over a reference period of time.

A change in distance, Δd, results in a change in frequency, Δf. This results in a change in phase rotation, Δυ_{rc}, over chirp period, T_{c}, as follows (c is the speed of light in a vacuum):

$$Δ {ϕ}_{r c} = 2 π Δ f {T}_{C} = \frac{4 π {a}_{f} Δ d {T}_{c}}{c}$$

This same change in distance results in a change in phase offset, Δϕ₀, for the same chirp period as follows (f is the radar carrier starting frequency, and λ is the wavelength):

$$Δ {ϕ}_{o} = \frac{4 π Δ d}{λ} = \frac{4 πΔ df}{c}$$

The ratio of Δϕ₀ to Δϕ_{rc} is (B is the chirp's sweep bandwidth):

$$\frac{Δ {ϕ}_{o}}{Δ {ϕ}_{r c}} = \frac{f}{{a}_{f} {T}_{c}} = \frac{f}{B}$$

The IWR6843AOP supports a sweep bandwidth of 4 GHz, with a starting frequency of 60 GHz, so the ratio of change in phase rotation over a chirp to phase shift for the chirp due to a change in length is 15:1.

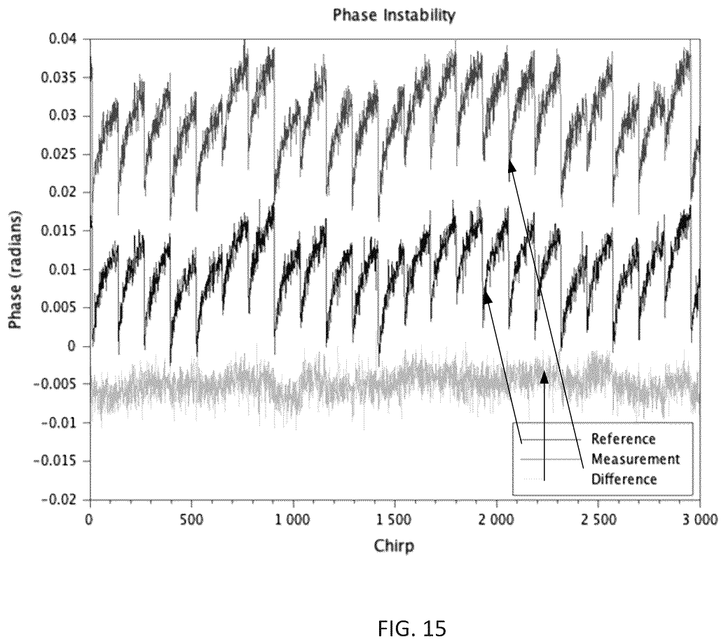

In an embodiment, the relative orientation of the devices may be determined by multiplexing between multiple transmit antennas discussed earlier, the phase shift of the reference and measurement locations due to chirp phase instability may be compensated for by performing a differential phase measurement from two reference locations. The phase at each location may follow the example pattern shown in FIG. 15, where the phase instability is common to both signals and may be significantly reduced using a differential measurement (each signal has been shifted vertically):

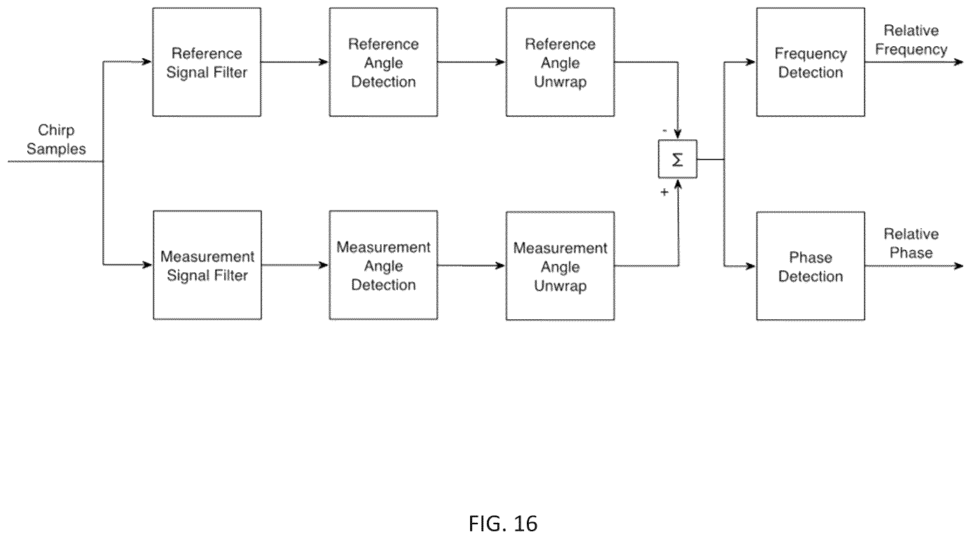

FIG. 16 depicts a block diagram which illustrates a system for determining the relative frequency and phase shift between the reference and measurement locations, using the technique described above.

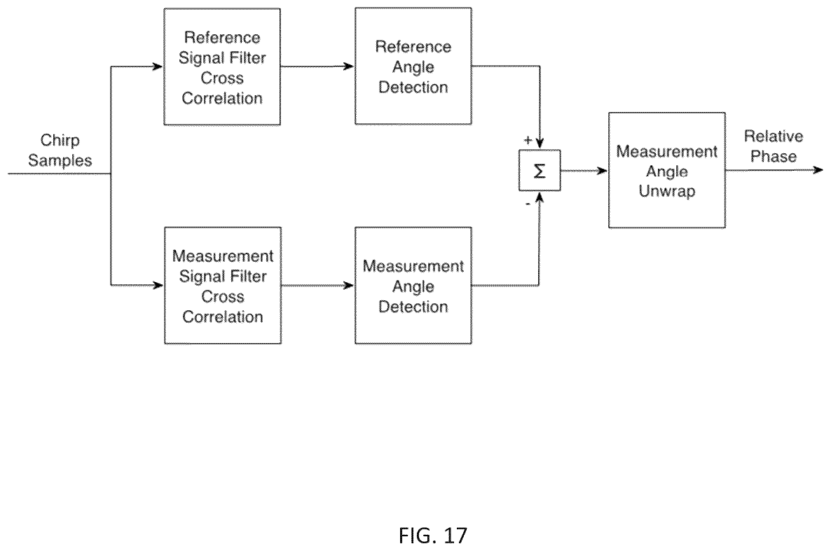

The demodulated I/F I/Q samples from a chirp are passed through two signal chains. The upper chain processes the reference signal and the lower processes the measurement signal. Each chain consists of a filter, angle measurement, and angle unwrap. The reference signal filter is designed to extract the reference frequency, and the measurement signal filter is designed to extract the measurement frequency. These may be bandpass, low-pass or high-pass filters with appropriately chosen passbands. For example, if the reference frequency were nominally 500 kHz, the reference signal filter may be a bandpass with a center frequency of 500 kHz, or a low-pass with a corner of 500 kHz or slightly higher. If the measurement frequency were nominally 1 MHz, the measurement signal filter may be a bandpass with a center frequency of 1 MHz, or a high-pass filter with a corner of 1 MHz or slightly lower. The angle measurement function computes the arctan of the ratio of Q to I of each sample to determine the instantaneous angle of the reference or measurement signal. The reference angle unwrap function adds pi radians when the angle decreases rather than increases, for a normally increasing angle. If the angle is normally decreasing, the unwrap function subtracts pi radians. The reference signal angle is subtracted from the measurement signal angle, and this result is processed to determine the frequency and phase shift. The frequency and phase may be measured through linear regression, where the slope represents the frequency and the vertical offset represents the phase shift. Other methods may be utilized, such as cross correlation with a slope basis function with zero DC component for measuring the slope as well as a cross correlation with a constant basis function for measuring the offset. Because the frequency represents the change in angle over time, multiple angle measurements over time are required for determining the frequency. However, if only the phase is required, then the method may be simplified by measuring fewer angles for each of the measurement and reference signals, even just one such measurement. If a single angle measurement is utilized, it may be based on the sample measured when the digital filters are full. For instance, if a 128 sample chirp is used along with a 128-deep digital filter, only one output sample is based on all samples from the chirp, and this sample is equivalent to the cross correlation of the filter coefficients with the time-reversed chirp samples. If a linear-phase filter is used, the filter coefficients are time-symmetric, so the time-reversal is unnecessary and a direct cross correlation of the chirp samples and filter coefficients may be used as shown in the block diagram depicted in FIG. 17.

The relative frequency and phase measurement techniques described above mitigate variability in delay in the transmit and receive signal chains. However, they do not mitigate thermal expansion and contraction in the waveguide, as this directly causes the distance between the reference and measurement locations to change. By utilizing this technique with two or more waveguides, each affixed to locations on a structure which experience equivalent thermal expansion but differing strains under load as described earlier, both effects may be mitigated. This results in a temperature-independent, robust, strain gauge replacement.

Instead of a waveguide, more complex cavity shapes may be used. These may be designed such that strains may be measured in multiple locations and in different dimensions. A long tube may be used, and the location and amount of pressure detected through measuring the locations of the reflections along the tube. Additionally, the transmit and receive antennas may be positioned at different locations to allow for more complex imaging.

The precision strain measurement devices described above may also be coupled with precision accelerometers. This allows for simultaneous measurement of both force, being proportional to strain, and acceleration, allowing for a measurement of the mass of the object. Because the force determined from the strain measurement described above will typically have an offset, changes in force with time may be divided by changes in acceleration to determine the mass. This method requires that the object be in motion, otherwise the changes in acceleration will be zero. However, when the object is in motion, the mass may be determined, and the offset force determined for use when stationary.

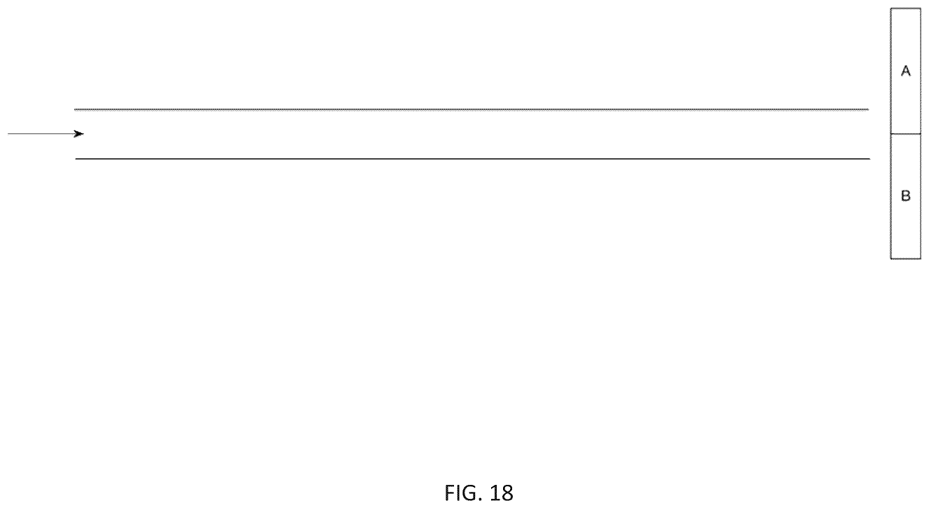

Besides the use of changes in phase and/or frequency to measure small distance changes, the use of changes in amplitude may also be used. This may be accomplished by changing the effective reflectivity of a target object, such as by using two different co-planar materials with different reflectivity. If the proportion of each material visible by an open-ended waveguide changes, the total amplitude of reflective material will change. This phenomenon may be utilized to sense shear motion transverse to the end of the waveguide. In the following diagram, a radar chirp is transmitted from the left, and reflects off materials A and B. These may be different metals, such as steel and copper, or one material may be an rf-absorbing material. As the reflectors move up and down relative to the waveguide end, the reflected signal amplitude will change based on the effective reflectivity of the two materials. As the reflectors move left and right, the signal amplitude will also change due to the attenuation of the radar signal in the gap between the end of the waveguide and the reflectors due to the inverse square law of free-space electromagnetic wave propagation. However, these distance changes may be measured using the phase and or frequency-based techniques described earlier. Once this distance is known, the amplitude may be corrected through application of the inverse square law or via characterization of amplitude and phase changes for the configuration. After correction, the remainder of the amplitude shift may be used to determine the vertical distance change of the reflectors. The result is that by using a single waveguide and FMCW transmit and receive channel, both changes in length and shear may be determined as shown in FIG. 18.

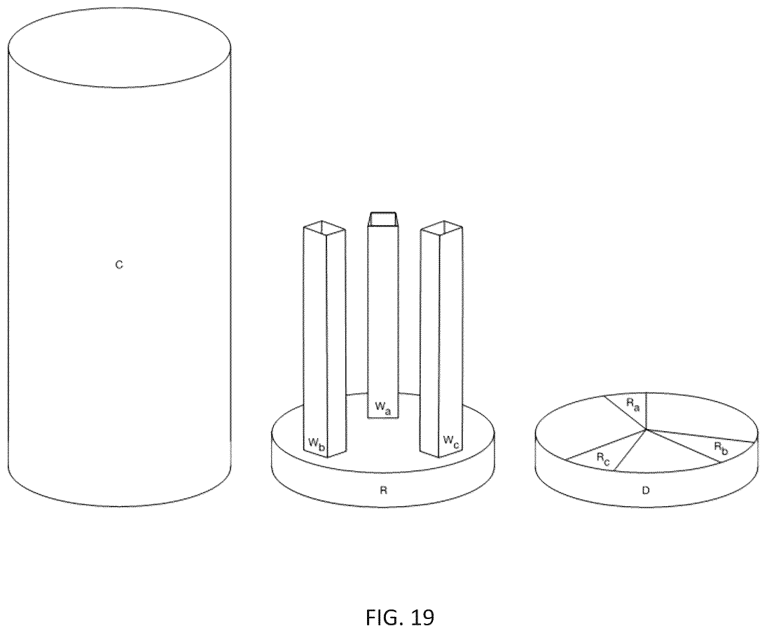

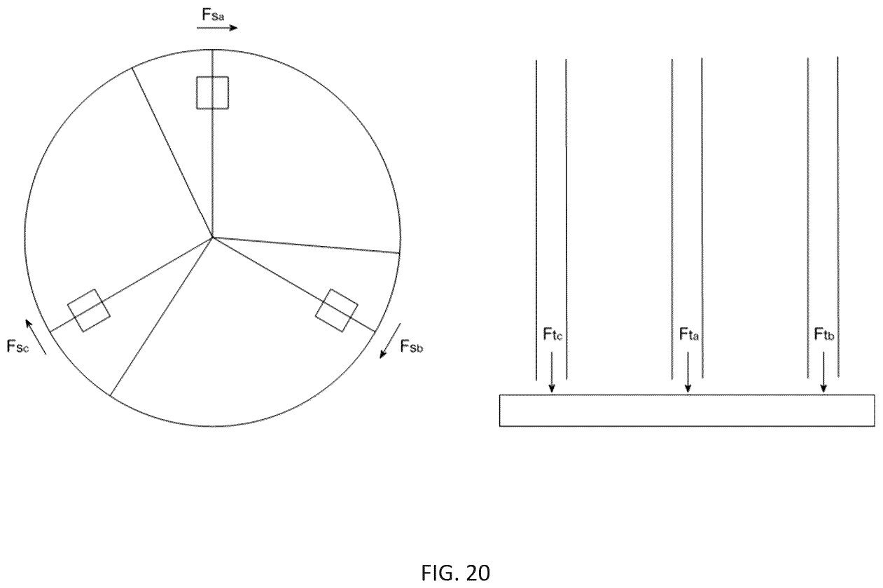

This concept may be further integrated into a load cell able to measure tension/compression, bending, shear and torsional forces. FIG. 19 is an example of such a universal load cell. C, is a hollow, internally threaded cylindrical tube. R is a three-channel FMCW radar module with three open-ended waveguides, Wa, Wb, and Wc, separated by 120 degrees. D is a disc with three reflectors, Ra, Rb, and Rc, also separated by 120 degrees. R and D thread into C such that the end of waveguides is some distance from the reflectors. This distance may be minimized to maximize the reflected signal strength but should be large enough to ensure that the waveguides do not touch the disc under the maximum expected compressive force. The reflectors may be aligned such that the edge of each reflector is nominally in the center of the matching waveguide. The reflectors should be wide enough that the waveguide end cannot pass over the other edge of the reflector under maximum shear or torsional stresses. Each module, R and D, should be sufficiently secure such that they do not rotate during operation. This may be achieved through different mechanisms such as sufficient baseline load applied to the load cell, using thread locker, using set screws, or expanding the diameter of the radar and or reflection disc such as through the use of screws that expand the diameter when inserted. This configuration allows for the measurement of force in two directions in three different locations as depicted in FIG. 20.

Fsa, Fsb, and Fsc are the tangential shear forces on the cycliner, and Fta, Ftb, and Ftc are the tensile forces. Each one of these forces may be detected in either positive or negative polarities. These measurements may be used in combination to separately detect the bending, shear and torsional forces applied to the load cell, as any of these forces may be decomposed into the above six forces. Further, the radar module may be include a 3-axis accelerometer as well as a single-axis gyroscope aligned to detect rotational acceleration along the axis of the load cell. By utilizing these inertial measurements in conjunction with the force measurements, the mass of the structure supported by the load cell may be measured unperturbed by external forces due to motion. With and without the accelerometer, this universal load cell allows for accuracy unachievable with traditional load cells.

Another method for determining the relative orientation of the devices is to have the transmitter multiplex between multiple antennas.

In an embodiment, the relative orientation of the devices may be determined by multiplexing between multiple transmit antennas. If the active transmit antenna and the relative separation between transmitting antennas is known to the receiving device, the orientation of the transmit antennas with respect to the receiver's antenna can be determined, by measuring the phase shift between the signal received from one transmit antenna to the next. If two transmit antennas are used, and the receiver is exactly aligned with the midpoint between the two antennas, then no phase shift will be seen as the distance to each antenna is the same. If the receiver is positioned to one side, say the left side, then a phase shift will be seen as the receiver is closer to the antenna positioned to on the left than the one on the right. Measuring this phase shift allows the angle between the vector corresponding to the signal direction and the antenna positions to be known. This technique can be performed in two dimensions, such as by using an array of three antennas arranged in an L configuration in a common plane. Both angle of arrival detection and transmit antenna multiplexing can be used to determine orientation of the antennas and the plane containing these antennas relative to the vector connecting the two devices.

Once the direction of the receiving device is known by the transmitting device by transmitting this information via a communication channel, the transmitting device may then elect to direct the beam at the receiving device using phased array techniques to maximize signal strength and minimize transmission to other devices. The FMCW devices may then exchange further data, such as the physical shape of the object to which the FMCW devices is attached, and the location and orientation of the FMCW device relative to the object. The result is a robust and accurate positioning technology, able to detect the range, direction, orientation, and speed of remote complex objects while operating in harsh environments such as rain, fog, snow, wind, or dust where, for example, visibility may be impaired.

Communications may also be secured through the use of encryption, such as public key cryptography. Each transmitter may choose to digitally sign its transmissions, so that the receiver can independently verify the identity of the transmitting device by validating the signature with a known public key. This may be implemented through the use of public key cryptography, where each device generates or is furnished with a pair of keys including a public key, which may be known to others and a private key which is not. A message digest generated from a hash of a message to be transmitted may be encrypted using a device's private key, and this encrypted hash (the signature) may be transmitted along with the public key and the accompanying data. A receiving device may verify the authorship of a message by computing a digest of the received message using the same method as the transmitter, then decrypting the received signature using the transmitting device's public key and then comparing the computed digest with the decrypted signature. If the two match, the receiving device can confirm that the message was signed by the private key paired with the public key. If a public key is known to be associated with a device, meaning it has exclusive access to the associated private key, a receiving device can confirm whether a received message originated from that device. This capability combined with the disclosed signal locating capabilities produces a system which not only detects the locations of objects in space and can learn of their identity but can also independently verify that identity. Public key cryptography may be further used to securely exchange encryption keys so that communications may be impervious to eavesdropping.

In an embodiment, a pair of devices may be configured to distinguish or otherwise identify that they are communicating with one another and not a third device based on the identity verification techniques described above. By combining this with the previously described device ranging and direction techniques, both the relative positions and identities of the devices may be confirmed. The systems and methods described herein allow for a device to facilitate selective communication where the device can discriminate between multiple other devices that are in the same environment or sensing area. In an example, a combine may be located with two grain carts nearby, one side by side and ready to receive a transfer and another trailing closely behind ready to get the next load from the combine. In this scenario where the combine is communicating transfer data with the grain cart, it can be assured that the combine is communicating with the correct one based on the location information in concert with the devices identifying themselves using the techniques described herein. The combine may establish communications with each grain cart using the described chirp phase-alignment methods, where it exchanges relative direction and distance data, as well as identification data. By using the direction data, it can determine which grain cart is best aligned physically to receive the transfer, and the identity of the cart may then be confirmed and associated with the grain transfer. It may optionally use ranging information to exclude those carts too distant to accept the transfer. Similarly, when there are multiple combines operating side by side with grain carts alongside each combine, etc. each combine can ensure it is communicating with the correct grain cart.

As shown in FIG. 2, each FMCW device may be packaged as a discrete sensor connected to power and data communications with one or more cables, such as controller area network (CAN), so that it can be easily located and oriented for optimum performance. Multiple sensor devices may then connect to a single computing module, for data capture and analysis, machine control, and data backhaul such as via Wi-Fi, Ethernet, cellular, satellite or point-to-point wireless.

Embodiments thus provide a system or method for, using standard or customized FMCW hardware installed on multiple mobile or stationary objects and configured as described herein, providing secure/reliable determination of signal origin from a select one of a plurality of geographically mobile machines, equipment, devices, or systems and subsequent selective establishment/facilitation of direct communication therewith. Embodiments include locating two FMCW systems such that they are in each other's sensing field of view and are then able to receive one another's transmitted signals. A direction vector to the source of the opposite's transmitted signal may be determined using an array of two or more receive antennas by calculating the angle of arrival in either the azimuth or elevation planes, or both, wherein the antennas may be arranged in a grid with ½ wavelength center-to-center separation. Each receiving FMCW device may determine the distance to its opposite using FMCW ranging techniques, resulting in the location (distance and direction) to the opposite FMCW transmitting system, relative to the receiving device, and sharing this information between the devices such that the relative direction and distance to, and orientation of, each device's opposite is then known to both. The transmit signals may be to send data, rather than simply performing scans, by using different chirp signals, defined by a number of characteristics, such as chirp rate, frequency range, ramp rate, amplitude and phase to send different symbols or other information-carrying signals, where those symbols/signals represent different pieces of data/information and wherein a chirp signal may be used to send one or more bits, or other types of data such as the identity of the object transmitting the signal, the receiving FMCW device can then detect these various chirp signals to receive and decode the transmitted data.

Embodiments provide a method for providing communications using frequency-modulated continuous-wave radar between two devices that are in each other's sensing field of view and are able to receive one another's transmitted signals, the method comprising: determining, by a first device using frequency-modulated continuous-wave radar, a direction vector to a source of a second device's transmitted signal using an array of two or more receive antennas by calculating an angle of arrival; determining, by the first device, a distance to the second device based on the transmitted signal; setting up a communications channel between the first device and second device, the communications channel using different chirp signals that are defined by a number of characteristics comprising one or more of a chirp rate, a frequency range, ramp rate, phase or amplitude; and communicating, by the first device, at least the determined direction vector and distance to the second device.

In an embodiment, the two or more receive antennas are arranged in a grid with ½ wavelength center-to-center separation. In an embodiment, determining the distance comprises: aligning, by the first device, a transmit frequency ramp signal for the first device with a received ramp signal from a second device to measure and communicate a ramp phase to the second device that is configured to subtract the phase as an offset from its own phase measurement. In an embodiment, determining the distance comprises: adjusting ramp signals of each transmit phase of the first device to align a start of the first device's chirp transmission to a start of a chirp the first device received. In an embodiment, the first device comprises at least one transmit antenna, the array of two or more receive antennas, and a processing unit. In an embodiment, setting up the communications channel comprises using phase modulation of the different chirp signals, wherein each device may transmit a sequence of phase-modulated chirps within a frame, with one phase-modulated chirp of the sequence of phase-modulated chirps containing a reference phase so that the difference in a phase between each chirp and the reference phase indicates data being sent. In an embodiment, a phase may be controlled with different resolution to change an amount of data sent with each chirp. In an embodiment, the method further includes receiving, by the first device, the second device, or the first device and second device a respective transmitted signal from a third device. The first device and second device are able to identify that they are communicating with one another and not the third device based on the communicating and/or a cryptographic signature. In an embodiment, the method further includes using the communications channel by one of the first and second devices to communicate data from the one of the first and second devices to the other of the first and second devices, the data comprising least one of identifying information, operating parameters, sensor readings, or environmental data.

Embodiments provide a system for providing communications using frequency-modulated continuous-wave radar. The system includes two devices that are in each other's sensing field of view and are able to receive one another's transmitted signals. The two devices are configured to communicate at least one of operating parameters, sensor readings, or environmental data therebetween using different chirp signals from the frequency-modulated continuous-wave radar, wherein the different chirp signals are defined by a number of characteristics comprising one or more of a chirp rate, a frequency range, or a ramp rate. In an embodiment, the two devices are further configured to determine a direction vector to a source of another device's transmitted signal using an array of two or more receive antennas. In an embodiment, the two devices are further configured to determine a distance to its opposite using the frequency-modulated continuous-wave radar. In an embodiment, each device of the two devices comprises at least one radar module in communication with a processing unit. In an embodiment, at least one of the two devices is coupled with a combine hopper, auger, grain cart, seed tender, grain truck, grain bin, or gravel truck. In an embodiment, the two devices are configured to communicate with the different chirp signals using binary phase modulation. In an embodiment, the system further includes an additional device that is in a sensing field of view of at least one of the two devices. The two devices are able to identify that the two devices are communicating with one another and not the additional device based on the communicating. In an embodiment, the two devices are configured to communicate with one another by having each device of the two devices transmit a sequence of phase-modulated chirps within a frame, with one the phase-modulated chirps containing a reference phase so that a difference in a phase between each chirp and the reference phase indicates the data being sent.

Embodiments further provide a method for communicating using frequency-modulated continuous-wave radar, the method comprising: determining a distance from a first device to a second device using frequency-modulated continuous-wave radar signals transmitted from the first device and the second device; determining a directional vector between the first device and second device using frequency-modulated continuous-wave radar transmitted from the first device and the second device; and communicating data between the first device and second device using chirp signals transmitted from the first device and the second device. In an embodiment, the chirp signals are defined by a number of characteristics comprising one or more of a chirp rate, a frequency range, or a ramp rate. In an embodiment, the two devices are able to identify that they are communicating with one another and not an additional device based on the communicating, such as based on characteristics of the chirp signals, and or based on content included within the communications, such as encrypted identification data, and/or for example, a cryptographic signature.

When the system or method is employed on a vehicle, such as a piece of mobile agricultural or construction machinery, it can be used to monitor and/or control the movement of the vehicle. Farm tractors are often equipped with automatic steering, and speed may also be controlled. One such application is for monitoring or controlling material transfers, e.g., the unloading of a combine harvester into a grain cart. This requires that both machines travel beside one another, introducing the risk of a collision. By utilizing this FMCW system on each machine, and having these systems face one another, the relative positions of each machine can be accurately measured and coordinated and used to send an alert when the machines get too close together, too far apart, too far ahead or too far behind, or even to allow for autonomous operation. Because the relative orientations of machines involved in material transfers follow standard operational practices (grain carts run parallel with combines and trucks while loading and unloading respectively, etc.), and such geometries can be determined by this system, in one embodiment using solely this positional and orientation information, the identities of the machines involved in a particular material transfer event can be reliably determined and tracked by having each device detect the positional and orientation information of the other machine within the same window of time. In another embodiment, the two devices may communicate data directly to identify each other and exchange information, as described above. If one or more of the machines is equipped with a scale or other volume measurement technology, the amount of material transferred and other information such as time, date, location, etc. may be exchanged and/or associated with the transfer event as well as the identities of the specific machines involved, as described elsewhere herein.

Because the system is also able to detect passive objects in the environment, collisions with objects such as power poles, trees, people, animals, or vehicles can be avoided. These accidents can cause serious injury, and result in expensive machine repair and downtime. Because accidents such as these are more likely at night due to limited visibility, this system is advantageous as it is able to operate independent of ambient lighting. Further, the system can detect low and/or wet spots in the terrain more accurately than can a human operator to serve as a warning system. Height variability is detected using ranging techniques, while moisture variability is detected through monitoring changes in the reflected amplitude corresponding to the region of the low spot.

As depicted in FIG. 1, the system or method may also be installed on the sides of a truck, such that the specific truck involved in a transfer can be identified and allows for alerting the truck operator when travelling close to obstacles. This simplifies the process of backing up a truck, which can be a challenge with a long trailer. Further, when backing up the truck to an auger with the described system, the position between the two can be accurately measured, greatly simplifying the maneuver. Also, by installing these devices both on an auger and a grain bin roof, it may be used to aid in the alignment of the auger spout with the bin opening. This can be a challenge for inexperienced drivers, especially with tall bins and long augers.

The system may also be installed on a swing-away auger, in order to automate the positioning of the swing hopper under the grain trailer. By using the system on the side of the trailer as well as on the main auger tube and mobile swing tube, this process can be fully automated, as the positions of all these components are accurately known relative to one another. Because the tube goes underneath the truck, this process requires careful coordination between the truck and the swing tube to avoid collisions and is currently manually controlled either via a wireless remote system or manually moving the swing tube. By coupling the system or devices with processing and motor drives on the swing tube, the process can be either fully or semi-automated. If the height of the grain in the swing-away hopper is measured using a FMCW device and automated control over the grain trailer's discharge gate is supported, the hopper grain level may be regulated in order to maximize the capacity of the auger. Further, this actuation prevents the auger hopper from overflowing if the auger is stopped unexpectedly.

In addition to, or in lieu of using position and orientation data, the use of the FMCW technology for communications, implemented in accordance with the disclosed embodiments as described herein, may also be used in other embodiments to automatically establish a communications channel between the operators of the machines, via audio, text, video, etc., when the machines are positioned for a transfer event. This allows the operators to communicate in a hands-free fashion during the transfer events, rather than needing to press a button on a traditional two-way radio. Then when the machines separate again, the communication link can be terminated. The operator interface may be via a tablet or dedicated terminal, in communication with the FMCW system.

In addition to, or in lieu of, using position and orientation data, the use of the FMCW technology for communications, implemented as described herein may also be used in other embodiments to automatically establish a communications channel between the machines to allow them to automatically identify one another and/or exchange information, e.g., data, operating parameters, sensor readings, environmental data, etc., therebetween, such as, speed, heading, distance between the machines, remaining fuel, obstacles ahead, initiation/cessation of transfer events, available/remaining material storage capacity, status of autonomous operation, operational capabilities, etc.

A further application of the FMCW system, implemented as escribe herein, is to measure the height, shape, and/or volume of grain or other granular material such as gravel stored in a hopper, vessel, pile, bin, or trailer, such as would be found in a combine hopper, grain cart, seed tender, grain truck, grain bin, gravel truck, gravel pile, etc. The system could also measure the level of liquid in a tank, such as a sprayer's water tank. If the antenna array is directed downward toward the grain, liquid, or other material, the ranging capability of the FMCW can serve as a real-time measurement of the volume of material in the container, which may be reported via a communications network. Changes in this volume may be used to determine that a transfer is occurring, which may indicate the normal flow of material in the operation or may indicate theft of material. The increase in volume as a function of time indicates that material is transferring into the container and may also be used to estimate yield in the case of a combine harvester. A decrease in volume as a function of time may also be used to indicate that material is transferring from the container. In the case of a grain bin, the sensor may be mounted on the underside of the roof, typically near an access panel to simplify installation. To measure the height of the grain in the bin, the transmit signal should ideally be directed downward. By embedding an accelerometer with the device, the beam can be steered by the angle measured based on the accelerometer readings, resulting in a downward-directed beam. The range from the measurement will have readings over a band of frequencies, based on the variability in the height of the pile. Because the grain is in the shape of a cylinder with a cone on top when filling, the effective height for a cylinder of the same volume as the cone can be calculated by measuring the distance to the peak of the cone from its base and dividing it by three. This is because the volume of a cone is ⅓ the volume of a cylinder of the same height for a given base diameter. This effective height can then be added to the height of the base of the cone from the bottom of the bin to derive an overall height representing the fill level and can be multiplied by the bin's cross-sectional area to derive a volume. Because the grain pile is in the shape of an inverted cone when emptying, the process is equivalent except the effective height of the cone is subtracted rather than added. This same method can be used for measuring the volume of grain in other containers, such as combine hoppers or grain cart tanks, though the shape of the container is more irregular than a round grain bin. If the grain bin is resting on a hopper cone, the volume of the cone can be modelled. The level of the bin can be measured both through frequency measurement and phase, as the phase will slowly advance as the grain pile becomes higher. This allows for an accurate estimate of bin load splits, which occurs when a truck load is split between two bins and the total weight is known. By measuring the increase in volume of each bin from the load, the weight may be accurately apportioned. If another FMCW device is used to detect whether grain is flowing from the grain trailer that is loading the bin, generally by mounting it on the auger or auger's swing tube and directing the transmit signal toward the stream of grain between the trailer's discharge chute and the auger's hopper, the specific truck and bin involved in the transfer may be detected by matching the flow detected from the truck and the bin. Another approach would be to mount the radar on the trailer facing the grain in the box, watch for a decrease in volume, and correlate this with the rise in volume in the bin. An unloading machine/device may exchange data (using the FMCW implementation or other) with a receiving/loading device to confirm the transfer and the amount thereof. The receiving/loading device may let the unloading device know when it is full or nearing full, etc. so that the transfer may be stopped, avoiding grain spillage or machine damage.

A further application of the FMCW system implemented as describe herein, is for use on a sprayer, both to measure the height of the boom height above the ground and for measuring the height of the crop canopy, by positioning the FMCW system above the crop canopy and directing it downward, measuring the distance of the reflection from the top of the crop canopy and the distance of the reflection from the ground. This may be used with automation systems to actively control the sprayer boom height to accommodate driving over uneven terrain and delivering consistent spray coverage. The canopy height data may be additionally collected as a measure of plant health. The canopy height may also be measured on a combine harvester, as a real-time approximation for crop yield, as crop height may be correlated with yield for a given crop within a field. This crop height data may be combined with location information, such as GPS, to create a map similar to a yield map. Because crop height is generally correlated with yield for many crop types, the ratio between yield and crop height may be determined for each harvester within the same harvested field, provided the FMCW system is used in conjunction with a yield monitor. A common problem is the consistent calibration of yield monitors between multiple combines, as any mismatch creates striping in the resulting yield map. Because the ratio between crop height and yield should be generally matched between combines harvesting in the same field, the yield data from each machine may be scaled such that the yield to height ratio is matched between machines, removing the striping. The resulting data can then be post calibrated by knowing the total weight of grain from the field, such as from a grain cart scale. The cart readings may be used on a load-by-load basis to determine the relationship between canopy height and yield. Further, another sensor may be oriented to measure the canopy height of the adjacent, unharvested field pass, typically in the direction opposite to the combine's unload auger. This sensor may be installed on this same side of the combine head or header, elevated such that it has an overhead view perpendicular to the direction of travel, combined with the overhead view in the direction of travel. This may be used to predict the yield in the adjacent pass to assist in predicting when and where the combine's hopper will be full. The height may be measured by measuring the height from above, or from the side. If measured from the side, an optical camera may be used to detect the height, by knowing the correct geometries, such as the distance to the crop and the angle of the camera relative to the crop.

The technique is also useful in forage harvesting applications to track movement of forage from harvester to truck, and in estimating the fill level or percentage of a truck or trailer. The device may either be installed on the truck or on the harvester looking into the trailer for the purposes of estimating the fill amount.

The FMCW system, implemented as describe herein, is also useful for feeding livestock from a feed mixer or wagon. These machines are designed to mix multiple ingredients together in specific proportions to create a feed ration optimized for the animals. The various ingredients are generally scooped up using a front-end loader or payloader and unloaded into the feed mixer in the required amount as monitored by a weighing system, which is typically vehicle mounted. This process is operator-controlled, and incorrect ingredients may be selected or the correct ingredients selected but loaded in the incorrect order. By placing a FMCW device in the locations where ingredients are stored and on the payloader, the system may detect which ingredient is being loaded and an alert may be presented if the incorrect one is selected. By placing one or more devices on the feed mixer, the system may identify whether the correct feed mixer is being loaded. After mixing, the feed mixer delivers feed to various pens. By placing these devices at each pen, the system may detect the identity of the pen that is being fed. This allows for a fully automated record keeping system, where the identities of the ingredients that are loaded and the pens that are fed are recorded, as well as the specific order in which those ingredients and pens are processed. Combined with an on-board weighing system, the amounts loaded and fed can be captured as well for a complete record of the entire process. Beyond the identities of ingredients and pens, the FMCW system can assist in the unloading process to ensure an even distribution of feed along each pen. FMCW devices can be placed on the front or rear of a feed truck or the combination of tractor and feed wagon as well as on the side of a post or other vertical surface at one end of the pen, aimed down the frontage of a pen where the feed vehicle will travel. The FMCW system's measurement capability (range and direction) allows the vehicle to determine its location along the length of the pen so that it can regulate the unload rate to ensure even distribution of feed along the whole length of the pen regardless of driving speed.

The FMCW system, implemented as describe herein, is also useful for backing up a truck to a loading dock. By placing a FMCW system, implemented as describe herein, near the loading dock, for example above the dock's door, and another one on the rear of the truck or truck trailer, the system may assist with both alignment between the truck/trailer and dock, and with communication between the two, allowing the operator to back up to the correct location without risk of collision. Additionally, automatic steering and drive features may be integrated to fully automate the back-up process. This would be similar to the park-assist features on consumer vehicles, with the difference being that precise angular and distance measurement may be made and shared between devices so that each device can determine the relative orientation of the other device, and the identity of the location to which the device is backing up is known. This could be used for validation that the correct dock for loading or unloading has been selected.

The technique is also useful for detecting of grain flowing from a spout, through a chute, or into a hopper by detecting the presence of grain, and optionally the speed of the flowing grain. A single device may be used to detect multiple chutes by using angle of arrival measurements, or by beam steering to find the angle corresponding to the largest signal corresponding to the moving grain. This angle can then be used to identify the chute. Alternatively, a device may be placed immediately facing the grain path for each chute, and a distance measurement (ranging) operation can be used to detect the flow. If the spouts are close enough to cause crosstalk, where a device detects the flow of multiple spouts, the correct one may be chosen by selecting the one with the largest signal. These chutes may be located on seed tenders, gravity wagons, grain trailers, etc.

The technique is also useful for shaft monitoring, e.g., drive or power take-off ΦTO) shaft. By placing a reflector on the shaft, the intensity of the reflected signal will be modulated by the reflector. The frequency modulation rate for a single reflector is determined by the speed of the shaft. Another method not requiring a reflector is using phase measurements to measure the speed of the shaft, provided the device is oriented such that some of the apparent motion of the shaft is longitudinal with respect to the device (normal to the device's antenna plane), as motion transverse to the direction of the wave propagation (parallel to the device's antenna plane) does not cause a phase shift of the reflected signal, but rather changes the angle of the reflection, which may be detected by measuring the angle of arrival. It may also result in a reduction in received amplitude. As the phase shift of the reflected signal is a function of the longitudinal component of the speed and not the transverse, the measured speed will change with the cosine of the angle between the device's antenna array plane and the axis of the shaft. If the device's antenna array plane and shaft's axis are parallel (the angle between the shaft's axis and the projection of the axis onto the plane is zero degrees), the speed of the extreme edges is entirely longitudinal, and if they are perpendicular (the angle between the shaft's axis and the projection of the axis onto the plane is 90 degrees), it is entirely transverse. Also, if the top of the shaft is moving away from the device, the bottom is moving towards, and vice versa. This causes the speed measurements to sum to zero when perfectly aligned, but if the transmitted signal is biased to one side of the shaft, either physically or through beam steering, a speed measurement can be made. Alternatively, either a portion of the top or bottom of the shaft may be electromagnetically shielded so more of the non-shielded portion is measured. This measurement will be some fraction of the actual speed, depending on how much of the opposite side of the shaft is measured. This can be used to detect whether a shaft is spinning or can be further calibrated if the actual speed is known. The reflector-based design allows a single device to read multiple shafts, provided they're sufficiently separated in distance. An example application would be for monitoring the shafts on a wide, multiblade, industrial mower, with many shafts for driving the blades. By using a reflector on each shaft desired to be monitored, one or more devices can remotely monitor the speed of each shaft and detect whether one begins to slow down relative to the other shafts. This generally indicates a slipping clutch, and the machine should be stopped to prevent machine damage. Another application would be monitoring the PTO shaft on a grain cart to determine whether the grain cart is being unloaded.

The technique is also useful as a linear displacement sensor, such as for measuring the extension of a hydraulic cylinder. By attaching a reflector directly or indirectly to the moving portion of a linear actuator, and directing the transmit signal toward the reflector, the position may be measured. Longitudinal movement will create a frequency shift for large motions, and a phase shift for small motions. Transverse movement will change the angle of arrival for the reflected signal. This allows for monitoring the state of various mechanical components, such as a door or gate, either in a binary open/close or continuous fashion.

In an embodiment, a system or method comprises: locating two FMCW systems such that they are in each other's sensing field of view, and are then able to receive one another's transmitted signals; determining a direction vector to the source of the opposite's transmitted signal using an array of two or more receive antennas by calculating the angle of arrival in either the azimuth or elevation planes, or both, wherein the antennas may be arranged in a grid with ½ wavelength center-to-center separation; determining, by each receiving FMCW device, the distance to its opposite using FMCW ranging techniques, resulting in the location (distance and direction) to the opposite FMCW transmitting system, relative to the receiving device, and sharing this information between the devices such that the relative direction and distance to, and orientation of, each device's opposite is then known to both; and using the transmit signals to send data, rather than simply performing scans, by using different chirp signals, defined by a number of characteristics, such as chirp rate, frequency range and ramp rate, to send different symbols or other information-carrying signals, where those symbols/signals represent different pieces of data/information and wherein a chirp signal may be used to send one or more bits, or other types of data such as the identity of the object transmitting the signal, the receiving FMCW device can then detect these various chirp signals to receive and decode the transmitted data.

Herein, the phrase “coupled with” is defined to mean directly connected to or indirectly connected through one or more intermediate components. Such intermediate components may include both hardware and software-based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions here before or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in the specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory may be supplemented by, or incorporated in, special purpose logic circuitry.

To provide for interaction with a user, embodiments of the subject matter described in this specification may be implemented on a device having a display, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A method for providing communications using frequency-modulated continuous-wave radar between two devices that are in each other's sensing field of view and are able to receive one another's transmitted signals, the method comprising:
determining, by a first device using frequency-modulated continuous-wave radar, a direction vector to a source of a second device's transmitted signal using an array of two or more receive antennas by calculating an angle of arrival;
determining, by the first device, a distance to the second device based on the transmitted signal;
setting up a communications channel between the first device and second device, the communications channel using different chirp signals that are defined by a number of characteristics comprising one or more of a chirp rate, a frequency range, a phase, an amplitude, or a ramp rate; and
communicating, by the first device, at least the determined direction vector and distance to the second device.

2. The method of claim 1, wherein the two or more receive antennas are arranged in a grid with ½ wavelength center-to-center separation.

3. The method of claim 1, wherein determining the distance comprises:
aligning, by the first device, a transmit frequency ramp signal for the first device to measure and communicate a ramp phase to the second device that is configured to subtract the phase as an offset from its own phase measurement.

4. The method of claim 1, wherein determining the distance comprises:
adjusting ramp signals of each transmit phase of the first device to align a start of the first device's chirp transmission to a start of a chirp the first device received.

5. The method of claim 1, wherein the first device comprises at least one transmit antenna, the array of two or more receive antennas, and a processing unit.

6. The method of claim 1, wherein setting up the communications channel comprises using phase modulation of the different chirp signals, wherein each device may transmit a sequence of phase-modulated chirps within a frame, with one phase modulated chirp of the sequence of phase-modulated chirps contains a reference phase so that the difference in a phase between each chirp and the reference phase indicates data being sent.

7. The method of claim 6, wherein the phase may be controlled with different resolution to change an amount of data sent with each chirp.

8. The method of claim 1, further comprising:
receiving, by the first device, the second device, or the first device and second device a respective transmitted signal from a third device;
wherein the first device and second device are able to identify that they are communicating with one another and not the third device based on the communicating.

9. The method of claim 1, further comprising:
using the communications channel by one of the first and second devices to communicate data from the one of the first and second devices to the other of the first and second devices, the data comprising at least one of identifying information, operating parameters, sensor readings, or environmental data.

10. A system for providing communications using frequency-modulated continuous-wave radar, the system comprising:
two devices that are in each other's sensing field of view and are able to receive one another's transmitted signals;
wherein the two devices are configured to communicate at least one of operating parameters, relative location information, identification information, sensor readings, or environmental data therebetween using different chirp signals from the frequency-modulated continuous-wave radar, wherein the different chirp signals are defined by a number of characteristics comprising one or more of a chirp rate, a frequency range, or a ramp rate.

11. The system of claim 10, wherein the two devices are further configured to determine a direction vector to a source of another device's transmitted signal using an array of two or more receive antennas.

12. The system of claim 10, wherein the two devices are further configured to determine a distance to its opposite using the frequency-modulated continuous-wave radar.

13. The system of claim 10, wherein each device of the two devices comprises at least one radar module in communication with a processing unit.

14. The system of claim 10, wherein at least one of the two devices is coupled with a combine hopper, auger, grain cart, seed tender, grain truck, grain bin, or gravel truck.

15. The system of claim 10, wherein the two devices are configured to communicate with the different chirp signals using binary phase modulation.

16. The system of claim 10, further comprising:
an additional device that is in a sensing field of view of at least one of the two devices;
wherein the two devices are able to identify that the two devices are communicating with one another and not the additional device based on the communicating.

17. The system of claim 10, wherein the two devices are configured to communicate with one another by having each device of the two devices transmit a sequence of phase-modulated chirps within a frame, with one the phase-modulated chirps containing a reference phase so that a difference in a phase between each chirp and the reference phase indicates the data being sent.

18. A method for communicating using frequency-modulated continuous-wave radar, the method comprising:
determining a distance from a first device to a second device using frequency-modulated continuous-wave radar signals transmitted from the first device and the second device;
determining a directional vector between the first device and second device using frequency-modulated continuous-wave radar transmitted from the first device and the second device; and
communicating data between the first device and second device using chirp signals transmitted from the first device and the second device.

19. The method of claim 18, wherein the chirp signals are defined by a number of characteristics comprising one or more of a chirp rate, a frequency range, or a ramp rate.

20. The method of claim 18, wherein the two devices are able to identify that they are communicating with one another and not an additional device based on the communicating.
